(19) United States
(12) Patent Application Publication
(10) Pub. No.: US 2018/0178824 A1
(43) Pub. Date: Jun. 28, 2018

(54) CONVERTIBLE STROLLER

(71) Applicant: Joller Stroller LLC, Saint Paul, MN (US)

(72) Inventors: Christy Hanson, Saint Paul, MN (US); Robert R. Roberts, Saint Paul, MN (US); Casimir August Sienkiewicz, Minneapolis, MN (US); Travis Ernest Yoch, Woodbury, MN (US); Peter Marshall Young, Minnetonka, MN (US)

(21) Appl. No.: 15/759,438

(22) PCT Filed: Sep. 12, 2016
(86) PCT No.: PCT/US16/51396

§ 371 Date: Mar. 12, 2018

Related U.S. Application Data
(63) Continuation of application No. 29/576,310, filed on Sep. 1, 2016, now Pat. No. D811950.
(60) Provisional application No. 62/294,034, filed on Feb. 11, 2016.
(60) Provisional application No. 62/217,176, filed on Sep. 11, 2015.

(51) Int. Cl. B62B 7/12; B62B 9/20; B62B 5/06; B62B 9/08; B62K 27/00

(52) U.S. Cl. CPC B62B 7/126; B62B 9/203; B62B 9/087; B62B 9/085; B62K 27/003; B62B 5/068

(57) ABSTRACT

An adjustable stroller having a main carriage and a handle bar assembly, wherein the handle bar assembly is configured to convert between push and pull configurations to enable a user to either push or pull the stroller. More specifically, the adjustable stroller includes the main carriage, pulling rails comprised of handle bar tubes and telescoping rail tubes, two rear wheels attached to the main carriage and the proximal ends of the pulling rails via wheel hubs, a cross bar and center handle configured to host conversion and brake mechanism controls, and a third, front wheel to offer stability and balance. The handle bar assembly in dudes the pulling rails and the cross bar and center handle. In the pull configuration, the distal ends of the pulling rails can attach to an adjustable running belt that a user can wear around the user's waist.

### CROSS-REFERENCE TO RELATED APPLICATIONS

The disclosed application is a continuation in part of U.S. Design Application No. 29/576,310, filed on Sep. 1, 2016, which is titled CONVERTIBLE STROLLER, and claims the benefit of U.S. Provisional Application No. 62/217,176, filed on Sep. 11, 2015, which is titled CONVERTIBLE STROLLER and U.S. Provisional Application No. 62/294,034, filed on Feb. 11, 2016, which is titled CONVERTIBLE STROLLER.

### FIELD OF THE DISCLOSURE

The disclosed invention relates to an adjustable stroller. More specifically, the disclosed invention relates to a stroller having a handle bar assembly that can rotate between a push configuration and a pull configuration to enable a user to either push or pull the stroller.

### BACKGROUND OF THE INVENTION

Strollers are used in a variety of situations to transport children or other persons with reduced mobility. They have become an important part of multi-modal, pedestrian-oriented transportation. Typically, parents or caregivers use them to bring children along when running errands or when the parent or caregiver is running or walking for recreational purposes. However, different strollers are required for different activities. For example, jogging strollers are operated in a similar fashion to traditional strollers, but are intended to permit higher-speed motion, such as running. While single-use strollers, such as those designed for running, serve a niche purpose, they require that users purchase additional strollers to meet other needs.

Further, current strollers are generally limited to being pushed from behind in order to cause forward motion. In addition, with current jogging strollers, arms are fixed on a central bar and users are unable to maintain the natural, swinging arm movement central to an efficient stride. Moreover, when pushing a stroller, hip movement is restricted and the torso must become rigid in order to steer the stroller. Because of this limited mobility of arms and hips, natural running posture is inhibited.

Existing strollers designed for runners are generally not suitable for children under six months of age as they require children to be able to hold their bodies upright within sling-styled carriages. In addition, parents desire enhanced and safer mobility with their babies and young children when running errands.

Therefore, a stroller is needed that is designed with the flexibility to meet the varied needs of families with young children, specifically, one that enables runners to maintain natural running posture, allows for the safe transport of children under six months of age, can be used for jogging and walking, and can be transformed to optimize its utility for walking.

### SUMMARY OF THE INVENTION

The present disclosure relates to a stroller that is capable of being converted into distinct configurations that allow a user to easily push and pull the stroller. By encompassing a pull-behind feature, the stroller enables a runner to maintain a natural running stride and engage both arms while pulling the stroller behind. The push feature enables a person to use the stroller in the traditional manner.

More specifically, the stroller may be pulled from a user's waist, rather than pushed with the user's hands, enabling the user to maintain a normal and natural stride engaging both arms. A simple adjustment transforms the stroller from running-mode into a traditional three-wheel, push stroller. The stroller can hold children of many ages and adapt to users of various heights.

### BRIEF DESCRIPTION OF THE DRAWINGS

FIG. 1 is a front right side perspective view of one embodiment of a convertible stroller in the pull configuration.

FIG. 2 is a front right side perspective view of one embodiment of the convertible stroller in the push configuration.

FIG. 3 is a back right side perspective view of one embodiment of the convertible stroller in the pull configuration.

FIG. 4 is a back right side perspective view of one embodiment of the convertible stroller in the push configuration.

FIG. 5 is a right side elevational view of one embodiment of the convertible stroller in the pull configuration.

FIG. 6 is a right side elevational view of one embodiment of the convertible stroller in the push configuration.

FIG. 7 is a front elevational view of one embodiment of the convertible stroller in the pull configuration.

FIG. 8 is a front elevational view of one embodiment of the convertible stroller in the push configuration.

FIG. 9 is a back elevational view of one embodiment of the convertible stroller in the pull configuration.

FIG. 10 is a back elevational view of one embodiment of the convertible stroller in the push configuration.

FIG. 11 is a top elevational view of one embodiment of the convertible stroller in the pull configuration.

FIG. 12 is a top elevational view of one embodiment of the convertible stroller in the push configuration.

FIG. 13 is a bottom elevational view of one embodiment of the convertible stroller in the pull configuration.

FIG. 14 is a bottom elevational view of one embodiment of the convertible stroller in the push configuration.

FIG. 15 illustrates the handle bar assembly of one embodiment of the convertible stroller in the push configuration and with the rail tubes in their stored configuration.

FIG. 16a illustrates the handle bar assembly of FIG. 15 in the pull configuration and with the rail tubes in their stored configuration.

FIG. 16b illustrates the handle bar assembly of FIG. 15 in the pull configuration and with the rail tubes in the partially expanded configuration.

FIG. 16c illustrates the handle bar assembly of FIG. 15 in the pull configuration and with the rail tubes in their expanded configuration and connected to a running belt.

FIG. 17a illustrates one embodiment of the convertible stroller in the push configuration.

FIG. 17b illustrates one embodiment of the convertible stroller in a mid-conversion configuration.

FIG. 17c illustrates one embodiment of the convertible stroller in the pull configuration.

FIG. 18 illustrates the conversion and braking mechanisms associated with one embodiment of the convertible stroller.

FIG. 19 is a front right side perspective view of one embodiment of the convertible stroller in the folded configuration.

FIG. 20 is a back right side perspective view of one embodiment of a running belt to be used with the convertible stroller.

FIG. 21 is a right side perspective view of the running belt of FIG. 20.

FIG. 22 is a front right side perspective view of the running belt of FIG. 20.

### DETAILED DESCRIPTION

The present disclosure relates to a stroller that users can easily and efficiently pull behind them when running and that users can quickly adjust to transform from a pull-behind configuration into a push configuration. Various embodiments of the stroller will be described in detail with reference to the drawings, wherein like reference numerals represent like parts and assemblies throughout the several views. Reference to various embodiments does not limit the scope of the stroller disclosed herein. Additionally, any examples set forth in this specification are not intended to be limiting and merely set forth some of the many possible embodiments for the stroller. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

General Background

In a preferred embodiment, the disclosed jogging stroller can toggle between two configurations, wherein one configuration enables a user to pull the stroller, and one configuration enables a user to push the stroller. Various embodiments of the disclosed stroller are illustrated herein.

In a first configuration, referred to herein as the “push configuration,” the disclosed stroller operates similarly to a standard walking stroller. However, in a second configuration, referred to herein as the “pull configuration,” the disclosed stroller turns the design of the common push stroller around, thereby overcoming the ergonomic challenges that are traditionally faced by runners. For example, users can pull the stroller from their waists rather than push it with their hands. More specifically, in one embodiment, the stroller is generally comprised of a carriage, a handle bar assembly having a handle bar and pulling rails, wheels, and a running belt removably attached to the distal end of the handle bar assembly. The user can pull the stroller by attaching the running belt to the user's waist or hips. This innovation transforms the running experience in two ways: first, a child sitting in the stroller can see the person pulling the stroller and, second, the user is able to maintain proper running form by engaging both arms and keeping a natural stride. In one embodiment, the user can adjust the brake settings to add some resistance to the carriage, which, in combination with the added weight of the stroller, enables the user to build the muscles most used and most needed for running. In some embodiments, the disclosed stroller is lightweight and ergonomic; has a universal base to accept car seats; is collapsible for easy storage; and is convertible from a two-wheeled pull-behind stroller to a three-wheeled push stroller. The stroller can hold children and/or cargo and adapt to users of many heights. For example, in some embodiments, the stroller can hold children weighing up to 60 pounds. In some embodiments, the stroller can have an anchor or a stable seat platform and universal car seat base clips to anchor a universal car seat base for children from less than six months of age to three years of age, inter-changeable seats for older children, and inter-changeable “windows” to protect children and/or cargo from cold, rain, and bugs. It can also have an adjustable running belt, telescoping pulling rails, and an adjustable carriage-to-user angle, all of which are features that enable the stroller to accommodate users of various sizes and preferences.

In a preferred embodiment, the total weight of the stroller will not exceed 25 pounds. The stroller can accommodate up to 120 pounds and seat one or two children. Generally, the stroller can be approximately 26 inches wide (from wheel to wheel) and approximately 36 inches tall (from ground to top of carriage).

Various forms of construction methods or processes can be used to create the stroller such as, but not limited to, rotational molding, injection molding, thermoforming, fabrics, composites, sheet metal, machined parts, and tube frame weldment. A preferred embodiment primarily uses an aluminum tube frame weldment with a fabric seat and carriage.

Carriage

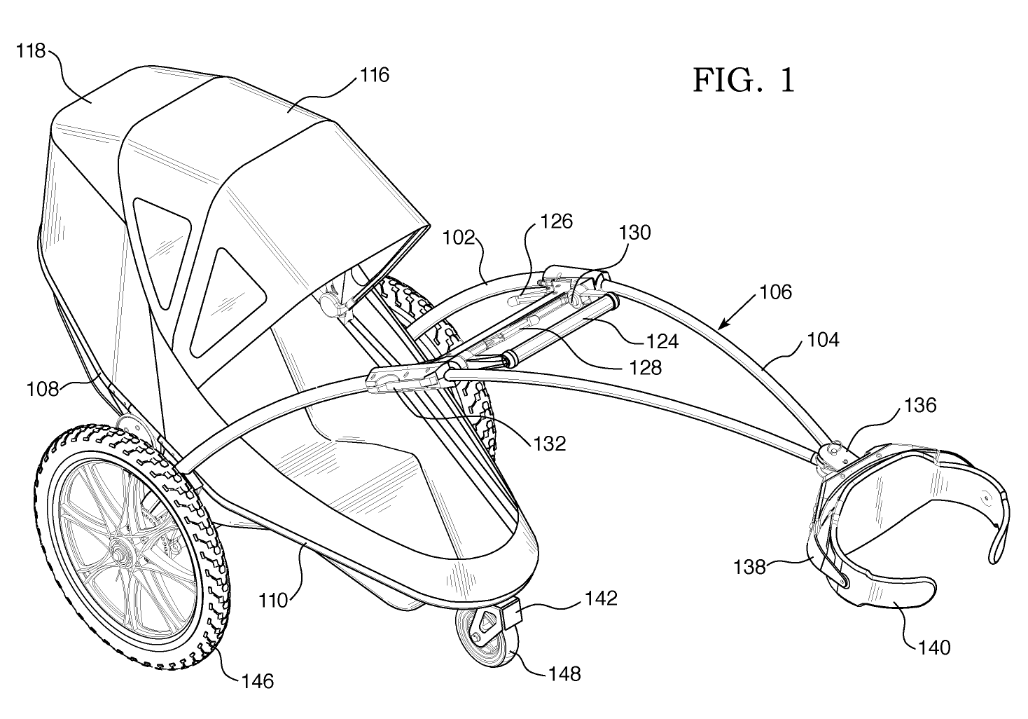

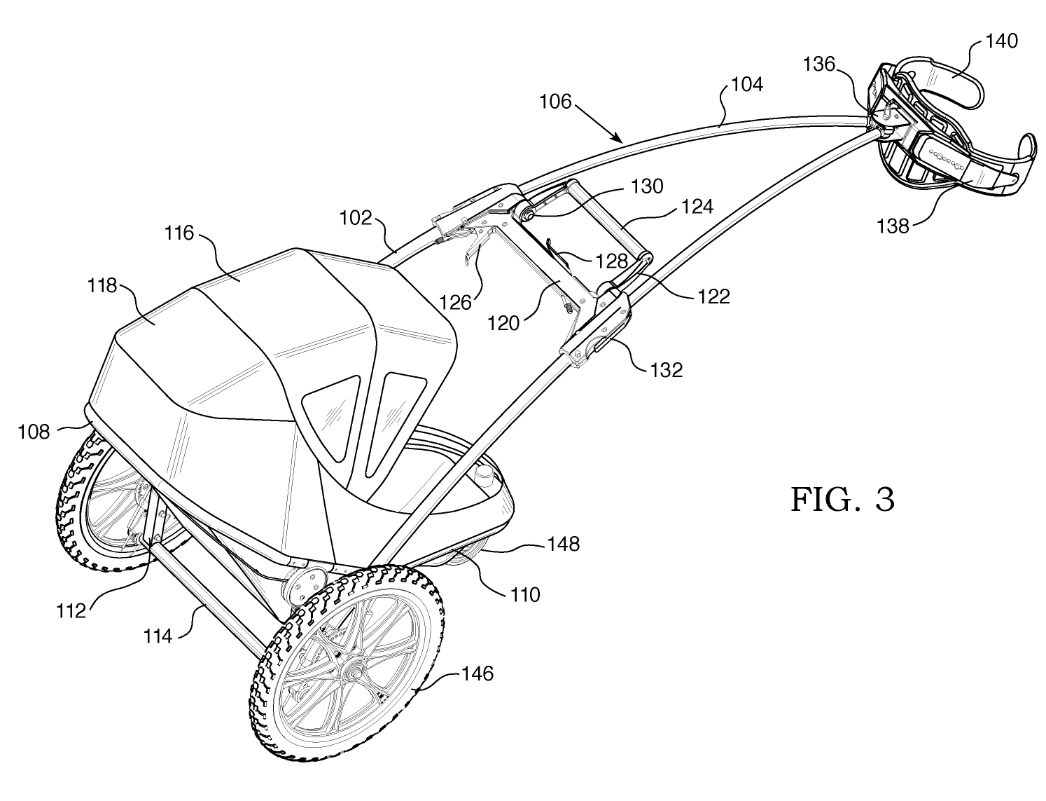

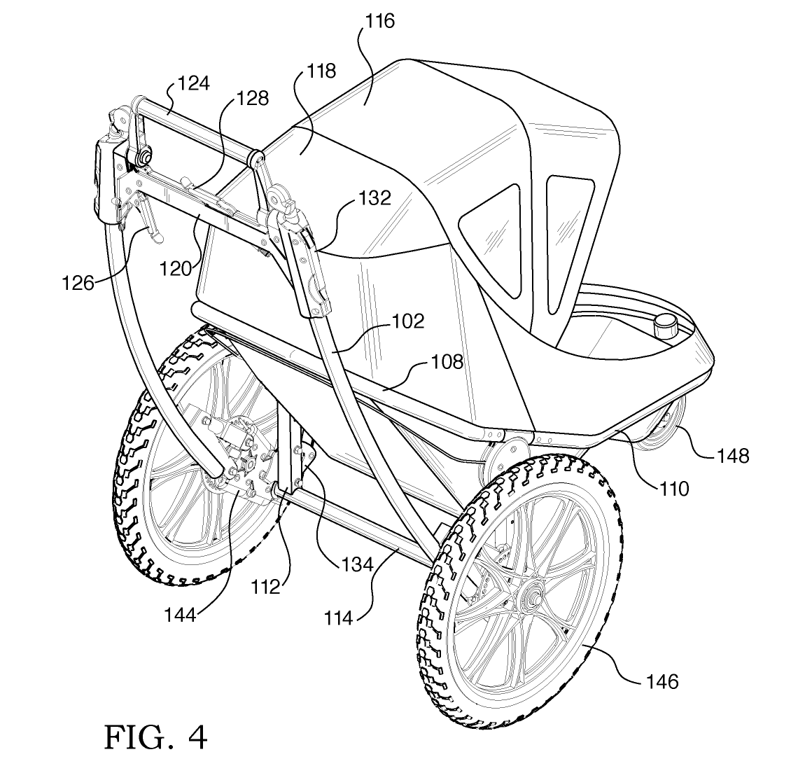

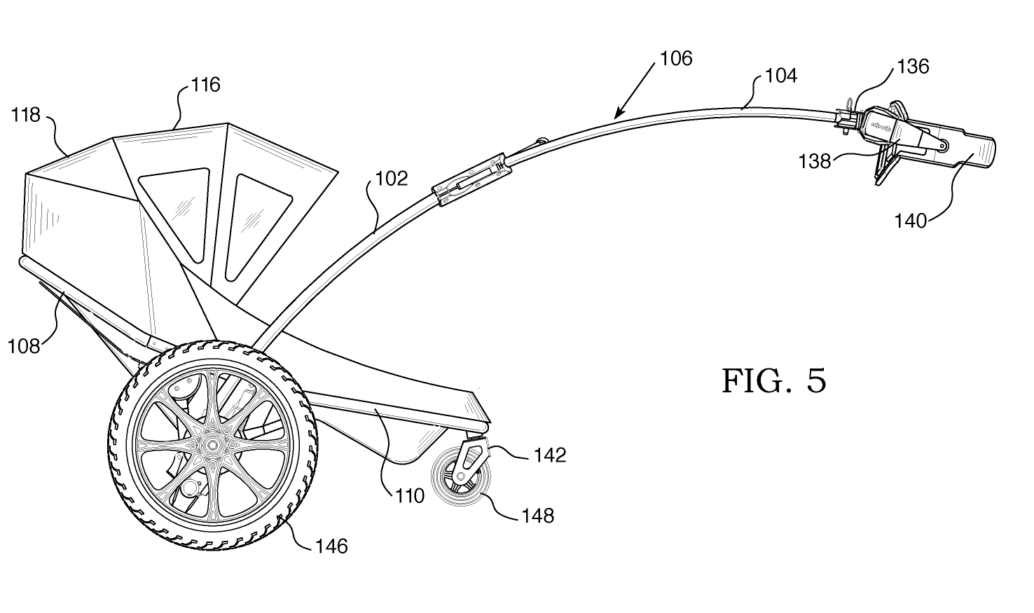

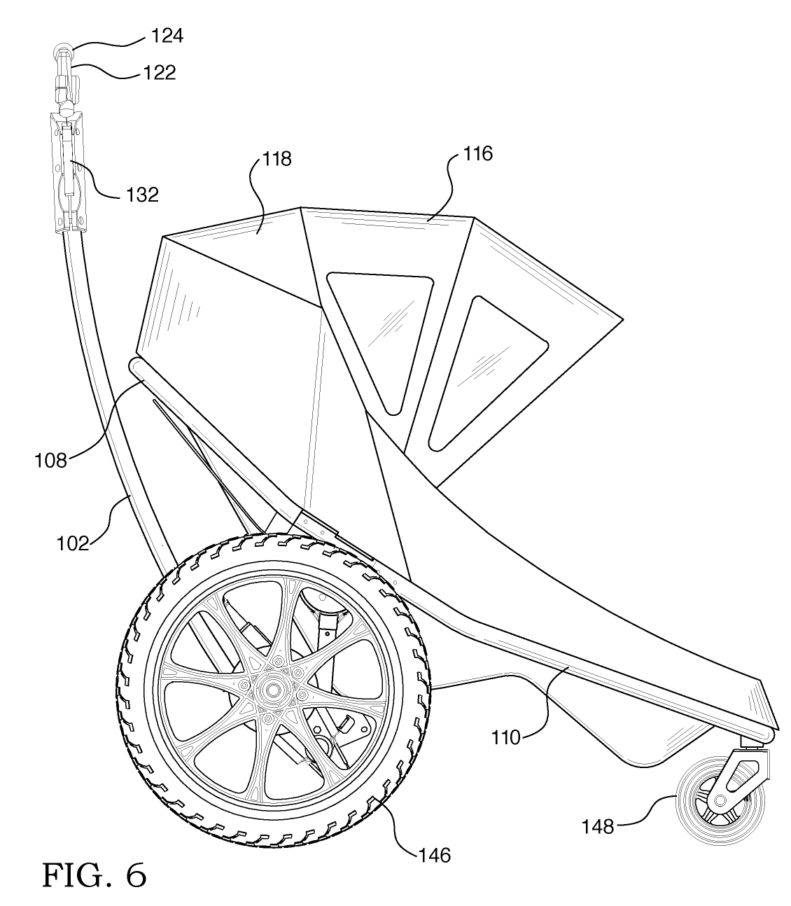

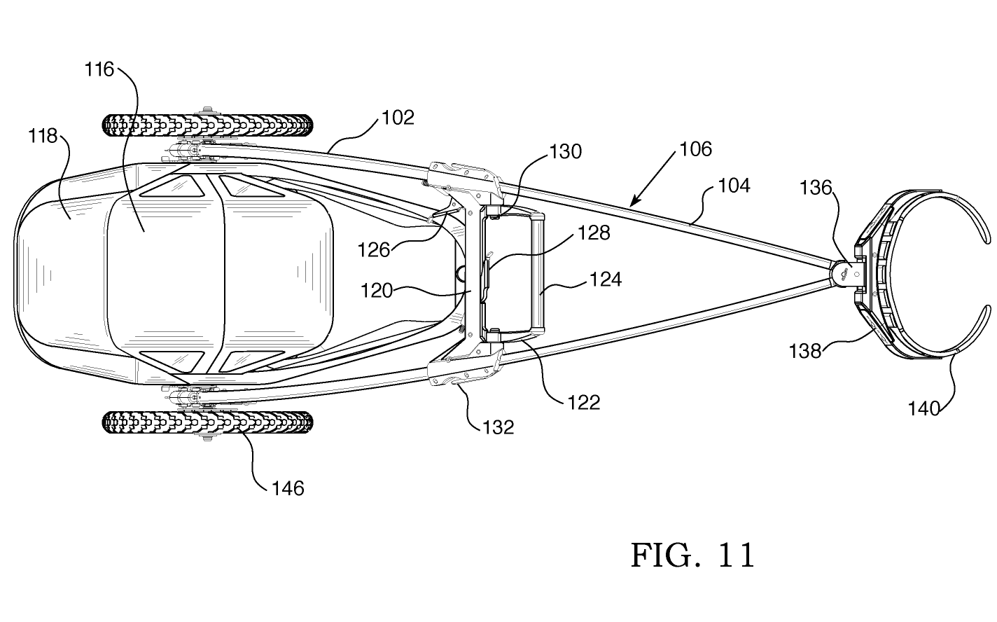

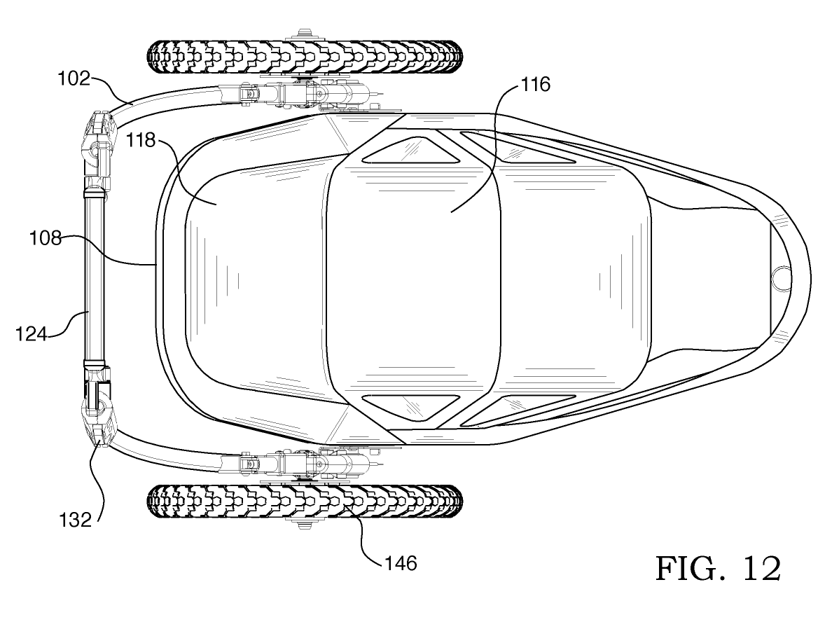

In some embodiments, the design theme of the carriage may be a pod shape, as illustrated in FIGS. 1-6. In some embodiments, the carriage frame assembly may have an elliptical shape or a triangular shape. The carriage frame assembly can be constructed from one piece, or it can be two or more pieces that are assembled at joints. In some embodiments, the carriage can convert from a fully open form to a partially open form in which the seat is exposed to air. Alternatively, the carriage may be permanently fixed in the fully open or partially open form, as illustrated in FIGS. 1-6 and 11-12. In some embodiments, the carriage can further convert to a completely closed form.

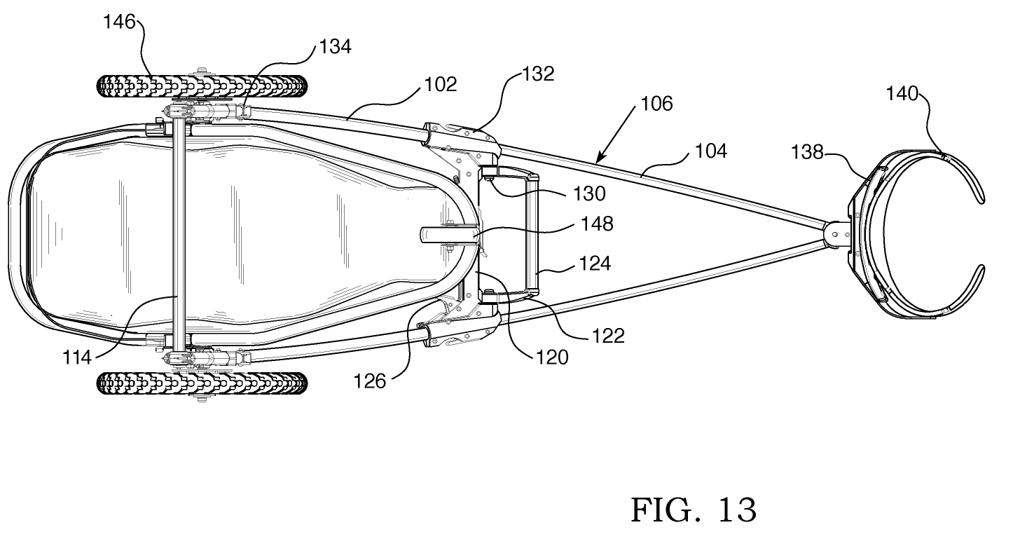

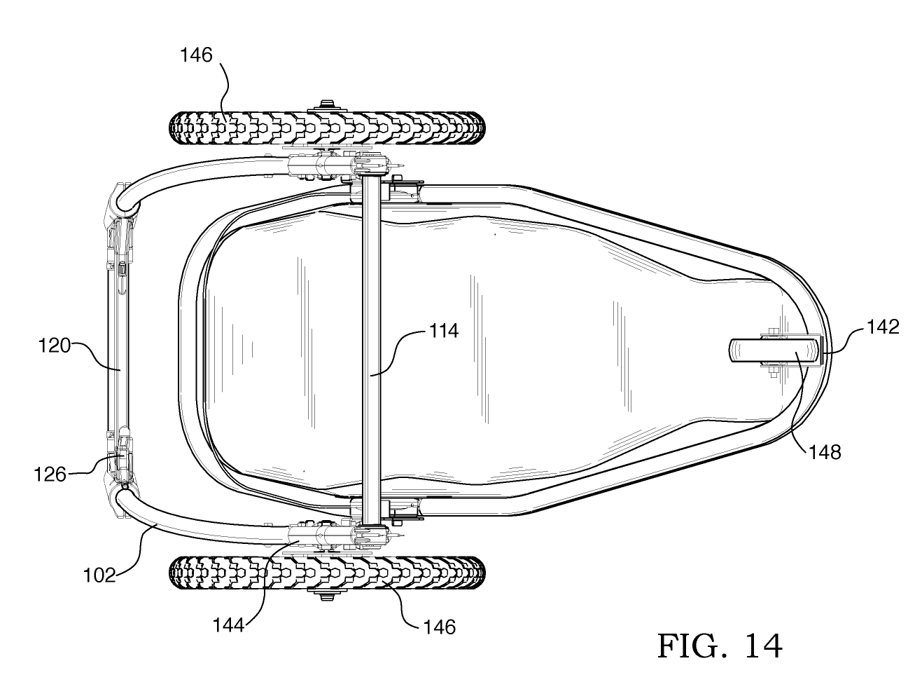

The wheel axles can attach directly to this carriage frame assembly or indirectly to the carriage frame via a wheel hub, as illustrated in FIGS. 13-14 and 18, and the pulling rails 106 can lock in place. Children or other cargo may be loaded into the stroller when it is in the partially or fully open form and either form, as well as the closed form, may be maintained while the stroller is in use.

By using the carriage in partially open or closed form, additional sun and weather protection may be possible. In embodiments where the carriage is in a partially open form, a canopy 116 or hood 118 may have an extra flap cover that covers a clear window. The flap cover may be secured using, for example, hook and loop fasteners (ex. Velcro®) and the window can be made of, for example, plastic. Additionally, the sides of the canopy 116 may have clear windows to lighten the inside of the stroller. In some embodiments, the carriage can offer two sliding extensions providing varying levels of weather protection. An arched sun visor can pull out from the carriage and extend to the top of the carriage and have fabric covering the top and overhanging the sides and be secured (for example, by hook and loop, buckles, buttons, ties, snaps, etc.). A front extension positioned in front of the sun visor can pull out from the bottom of the carriage and slide up to engage the sun visor forming a full pod. Alternatively, it can extend out from the front of the sun visor or it can be a separate piece that, when used on the stroller, is secured on all sides using a zipper, buttons, hook and loop fasteners, etc.

Ripstop nylon may be the primary material used for the carriage's fabric components and may attach to the frame, thereby creating the circular sides of the stroller. Netting can be used as a permanent fabric over the windows, with an option of coated ripstop nylon placed over the window in case of rain or other inclement weather.

Front Wheel

The key feature of the disclosed invention is the stroller's hybrid ability to be either pulled or pushed. When pulled, the user is in front of the carriage, the handle bar assembly is positioned in front of the carriage and behind the user, the stroller is connected to the user at the user's waist, and there are two rear wheels 146 on the ground supporting the carriage, as illustrated in FIGS. 1, 3, 5, 11, and 13.

A third wheel 148 can be included on the stroller and attached to the carriage frame assembly via a front castor 142, but disengaged in the pull configuration. For example, in some embodiments, the third wheel 148 can be stored under the carriage in the pull configuration and can swing forward and lock in place in the push configuration to provide a stable, steerable, triangular wheelbase for the stroller. More specifically, the third wheel 148 can operate on a hinge, enabling it to swing forward and backward. In another embodiment, the third wheel 148 can rotate from a vertical engaged position to a horizontal disengaged position using a spring detent. In a further embodiment, the third wheel 148 can be removed, and the stroller can have designated storage for the wheel 148. By moving the wheel 148 backward or horizontal or by removing the wheel 148 altogether, greater clearance is achieved between the bottom parts of the stroller and the ground. In some embodiments, a fourth wheel may be added behind the rear wheels 146 to offer stability in the pull configuration.

In some embodiments, instead of being actively engaged or disengaged, the third wheel 148 can be fixed in its position, but be sized and/or positioned so that it does not touch the ground while the user is running. However, it can touch the ground and offer balance when the user detaches the handle bar assembly from the user's running belt 2000 while the stroller is in pull configuration or, in some embodiments, it can touch the ground while still attached to the user's running belt 2000 if the stroller is not locked in its pull configuration. The third wheel 148 allows for easy loading and unloading of children or other cargo. Therefore, when the stroller is in the push configuration, the user is behind the carriage, the handle bar assembly is in position behind the carriage allowing the user to push the stroller, and the third wheel 148, as described above, is engaged in the front of the carriage.

Pulling Rails

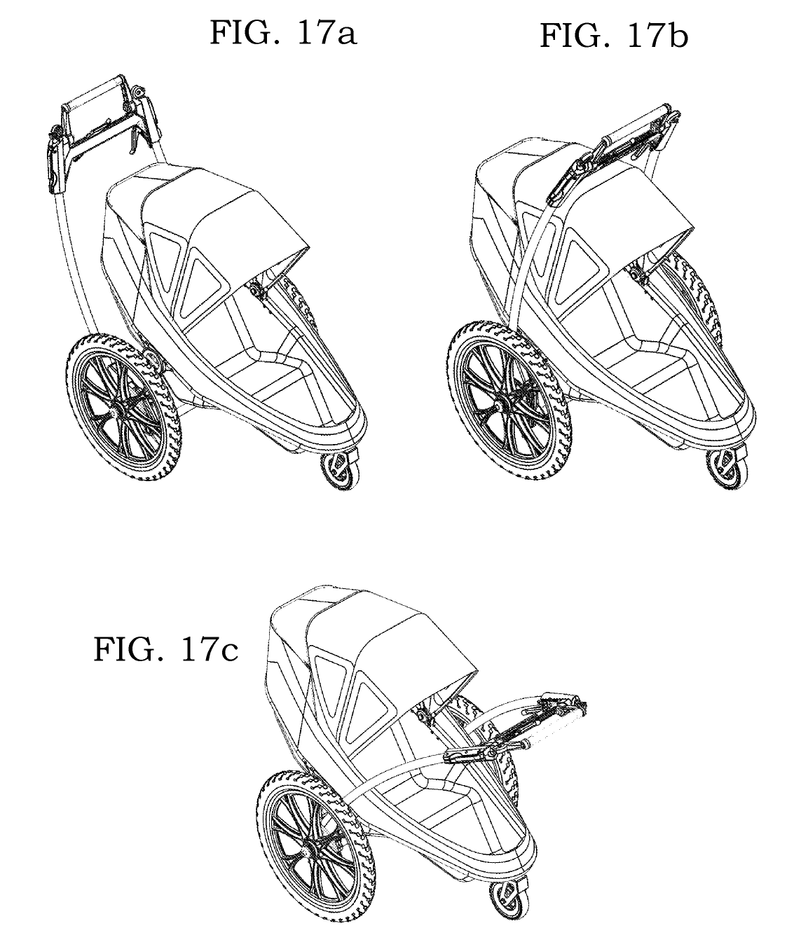

The conversion of the stroller to two-wheeled running-mode from a traditional three-wheeled, push stroller involves a simple adjustment for the user. If the user is using the stroller in the traditional, push configuration and wishes to use the stroller in the pull configuration, the user can rapidly convert the stroller to a two-wheeled pull stroller without removing the child or cargo by, for example, rotating the handle bar assembly over the top of the carriage, as illustrated in the sequence of drawings in FIGS. 17a through 17c.

In some embodiments of the disclosed stroller, the frame of the carriage can attach to two reverse-Z or S-shaped pulling rails. The pulling rails can extend from the axle, run parallel to the ground under the carriage, and then make an S- or Z-bend up to the user. When in position to roll forward, the top and bottom of the pulling rails can be parallel to the ground, and the middle portion can connect the bottom part and top part by extending at an angle. From the back, there may be at least one tube running parallel to the axle across the bottom and/or top of the carriage core. This can support the seat and serve as the base for the sun visor.

In some embodiments, for each S- or Z-shaped pulling rail, the pulling rail may extend approximately 16 inches from its axle and then angle up at about 45 degrees. From there, it can bend again parallel to the ground and extend approximately 36 inches to the point of attachment to the user. To accommodate various heights of users, the height of the attachment point to the user can be adjustable, spanning 32 inches to 46 inches. This adjustment may occur on the angled portion of the pulling rail.

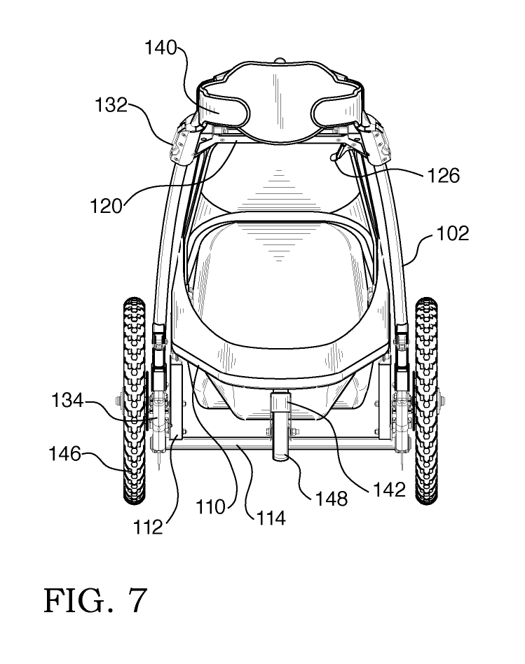

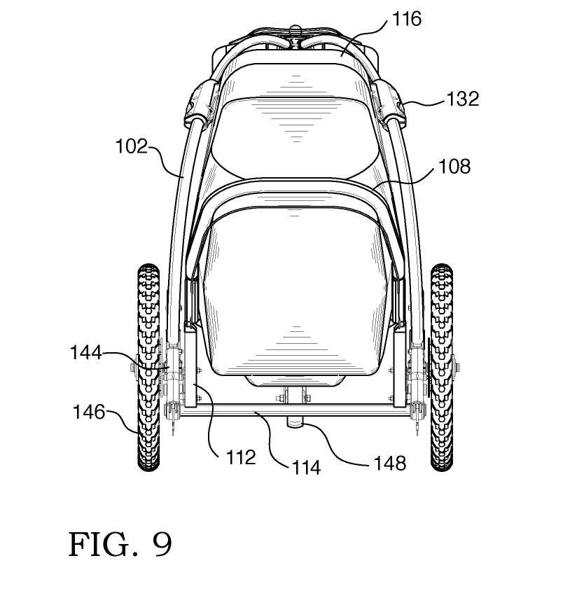

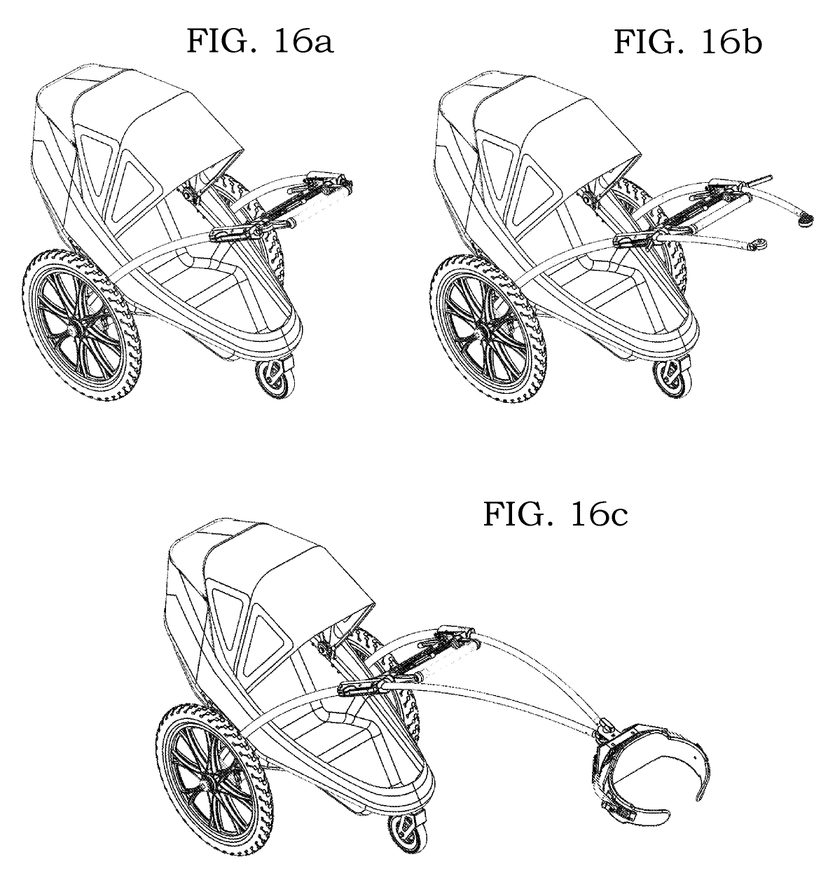

In a preferred embodiment, illustrated in FIG. 1, the pulling rails 106 are comprised of handle bar tubes 102 and rail tubes 104, wherein the rail tubes 104 are configured to be stored when the stroller is in the push configuration and are configured to expand and lengthen the reach of the handle bar tubes 102 when the stroller is in the pull configuration, as illustrated in FIGS. 16a-c. Further, the stroller's handle bar assembly can be comprised of two main pieces: (1) a handle frame having a pair of handle bar tubes 102 and a cross bar 120 to which the handle components are attached, the handle frame being attached to the carriage via the hub 144, the wheel axle 1812, or a horizontal carriage bar on the carriage frame and (2) a pair of rail tubes 104 that connect to the handle frame and extend the length of the handle bar tubes 102 when the stroller is in the pull configuration. These two main pieces can be used in combination to create the push configuration and the pull configuration. In the push configuration, the handle frame can be used to store the pair of rail tubes 104, and, in the pull configuration, the rail tubes 104 can extend out from the handle bar tubes 102 and connect on their distal ends to each other or a third object to create the extended pulling rails 106 and an attachment point for a user. In some embodiments, the attachment point is on a user's running belt 2000, as illustrated in FIGS. 1, 3, 5, 7, 9, 11, and 13.

Pulling Rails: Handle Frame

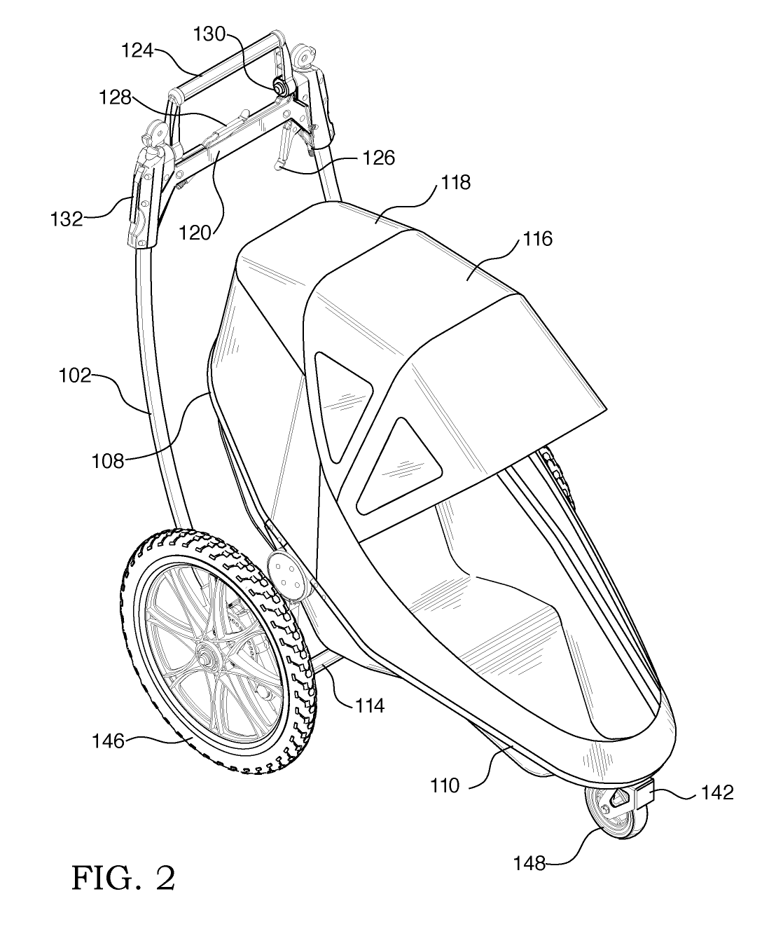

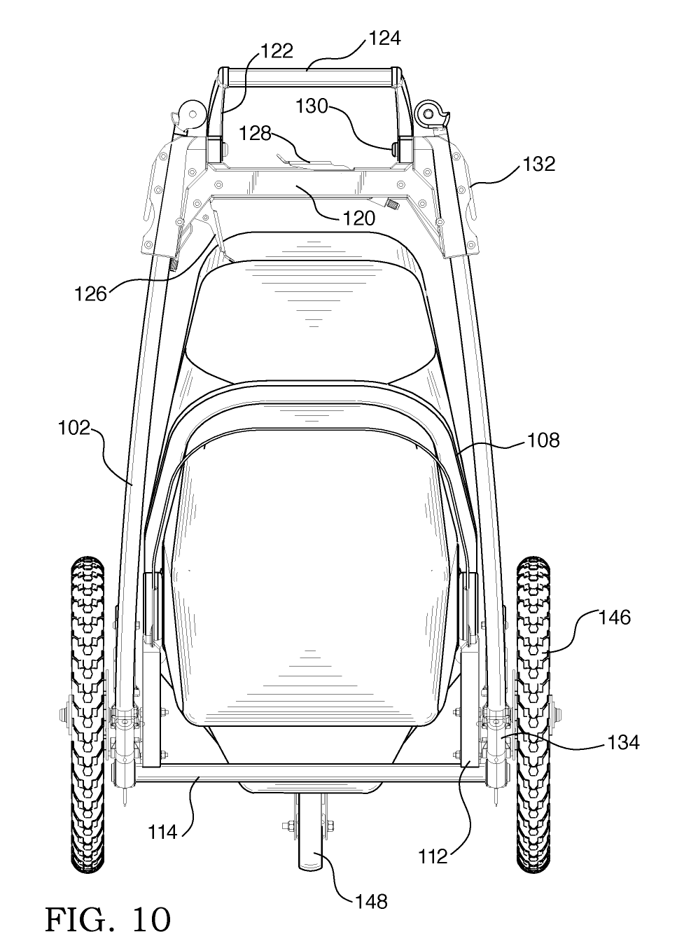

The first of the two main pieces, the handle frame, can be comprised of three components: left and right handle bar tubes 102 having proximal and distal ends and a cross bar 120 connecting to the distal ends of the left and right handle bar tubes 102, thereby create an inverted “U” shape as illustrated in FIGS. 2, 4, 8, and 10.

In some embodiments, the left handle bar tube 102 connects on its proximal end end to a left pivot and on its distal end to the cross bar 120, and the axle 1812 of the left rear wheel 146 is attached directly or indirectly to the left handle bar tube 102 between the first end of the left handle bar tube 102 that is connected to the left pivot and the second end of the left handle bar tube 102 that is connected to the cross bar 120. Similarly, the right handle bar tube 102 connects on its proximal end to a right pivot and on its distal end to the cross bar 120, and the axle 1812 of the right rear wheel 146 is attached directly or indirectly to the right handle bar tube 102 between the first end of the right handle bar tube 102 that is connected to the right pivot and the second end of the right handle bar tube 102 that is connected to the cross bar 120. In this embodiment, the left and right handle bar tubes 102 can rotate at their connection points to the pivots to move their ends from the front of the stroller to the back of the stroller and vice versa. The cross bar 120 preferably stays in place between the left and right handle bar tubes 102 as they rotate back and forth but, in some embodiments, the cross bar 120 can become detached at one or both of its ends. Therefore, as the left and right handle bar tubes 102 rotate, for example, forward, the left and right rear wheels 146 can also shift forward. This feature enables the stroller to change the center of mass, as described in more detail below.

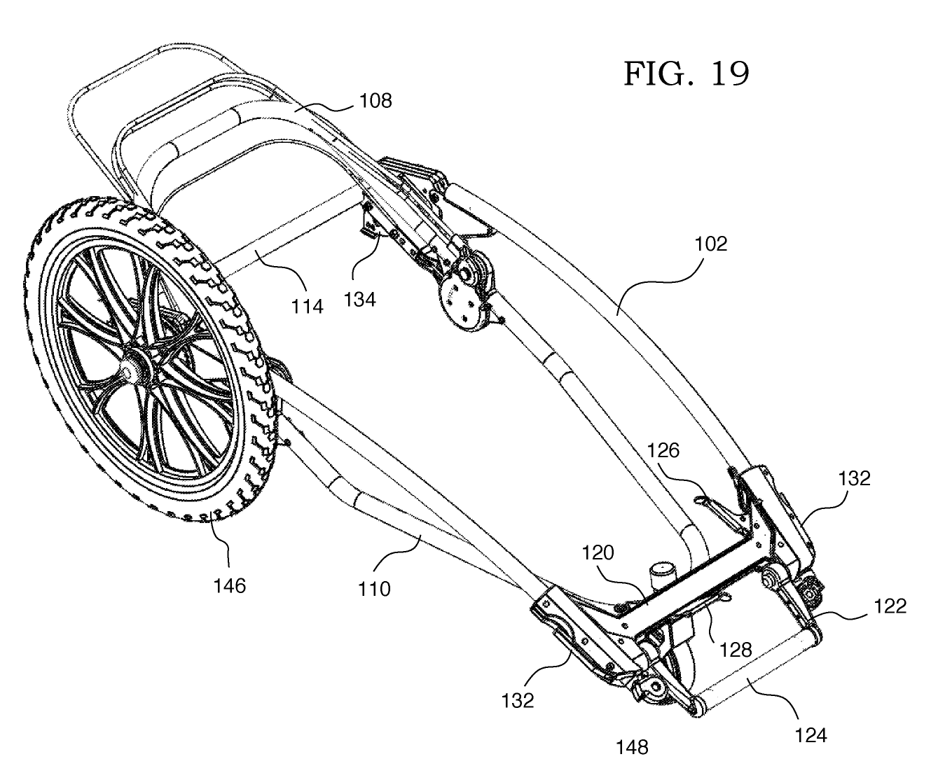

In other embodiments, the proximal ends of the left and right handle bar tubes 102 are each attached directly to a wheel hub 144 and the distal ends of the left and right handle bar tubes 102 are each attached to the cross bar 120, as illustrated in FIG. 19. In this embodiment, the left and right handle bar tubes 102 can rotate between push and pull configurations by virtue of their connection to the hub 144, which rotates in relation to a conversion plate 134. This rotation process is described in more detail below with regard to conversion of the disclosed stroller between push and pull configurations.

In some embodiments, the handle frame can also contain alternate grips. For example, the handle frame may have, in addition to the main, center handle 124, two side handles: a first side handle connected to the outside left portion of the cross bar 120 and a second handle connected to the outside right portion of the cross bar 120. In order to accommodate the rotation of the left and right handle bar tubes 102 when moving the stroller between push and pull configurations, the two handles may have to swivel outwards away from the path of the transitioning left and right handle bar tubes 102. They may also completely detach from the handle frame.

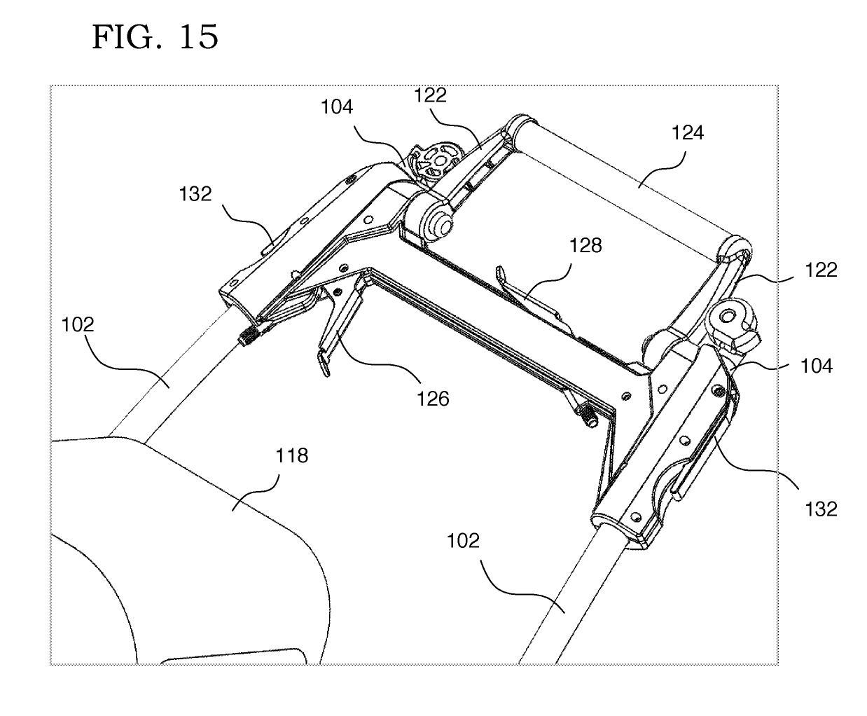

Another example of an alternate grip is a center handle 124 attached to the cross bar 120, wherein the center handle 124 is centrally located and runs parallel to the cross bar 120, as illustrated in FIG. 15. This center handle 124 may connect to the cross bar 120 via a left and right handle mount 122. Additionally, the center handle 124 and handle mounts 122 may be permanently affixed or may be removable from the cross bar 120.

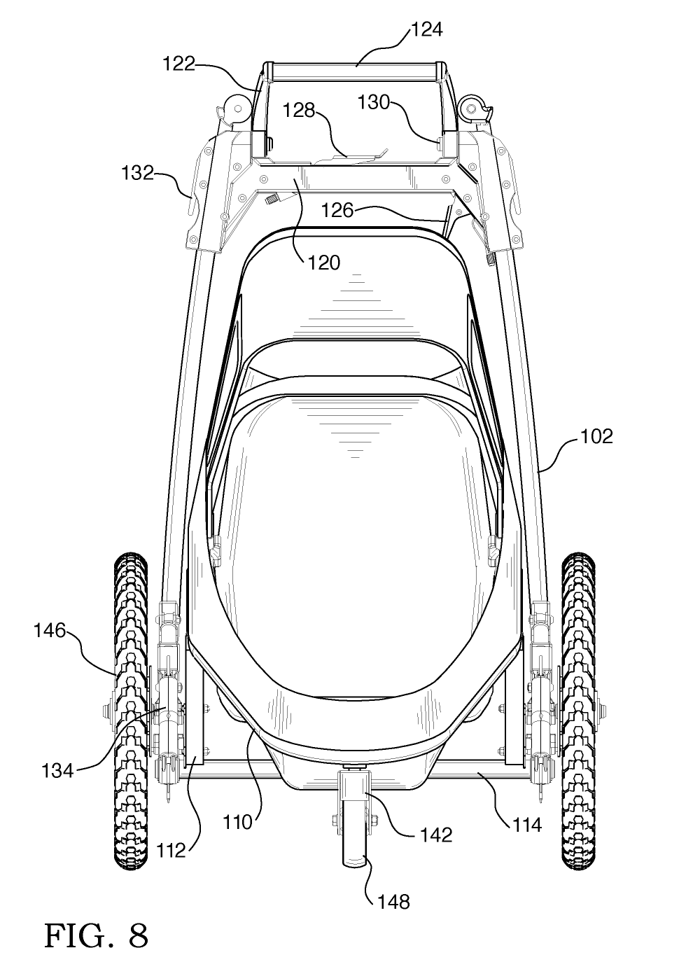

The handle mounts 122 may rotate, thereby permitting a user to adjust the position of the center handle 124. In some embodiments, the center handle 124 is adjustable when a user activates a rotation mechanism. For example, as illustrated in FIGS. 8, 10, and 15, handle adjust buttons 130 can be located on the right and left handle mounts 122 and, when a user pushes both handle adjust buttons 130, the right and left handle mounts 122 are free to rotate, thereby adjusting the position of the center handle 124.

The adjustable feature is useful in the push configuration because it can accommodate users of different heights. For example, a taller person may want to adjust the center handle 124 upward, while a shorter person may want to adjust it downward. Additionally, in the pull configuration, a user can adjust the center handle 124 to be in line with the handle bar tubes 102, and when the stroller is folded flat, the user can adjust the center handle 124 to be flat and in line with the remainder of the stroller frame, as illustrated in FIGS. 1, 3, and 5.

As illustrated in FIG. 15 and explained throughout this disclosure, specific functions of the convertible stroller, such as the handle adjust buttons 130 described above, can be controlled by release or locking triggers located on the cross bar 120. For example, cam levers 132 may be located on the parts of the cross bar 120 that attach to the left and right handle bar tubes 102, wherein the cam levers 132 release left and right telescoping rail tubes 104, as described further below. Additionally, a conversion lever 126 located on the underside of the cross bar 120 can be configured to initiate the conversion of the stroller between the push and pull configurations. In some embodiments, a parking brake lever 128 located on the cross bar 120 can be pulled to engage a parking brake, also described below.

Pulling Rails: Extension Rails

As described above, the stroller's handle bar assembly can be comprised of two main pieces: (1) a handle frame having handle bar tubes 102 and the cross bar 120 and (2) a pair of extension rails, such as rail tubes 104, that extend past the cross bar 120. In one embodiment, the rail tubes 104 are telescoping rail tubes 104 that can, in some embodiments, be bowed and can remain attached at their proximal ends to the handle frame and at their distal ends to each other and/or to a bridge piece, as illustrated in FIGS. 1, 3, 11, and 13. The bridge piece can be, for example a u-joint or an attachment bracket 136. More specifically, the proximal ends of each rail tube 104 can attach to the cross bar 120 or to their respective handle bar tube 102 on the handle frame.

In one embodiment, the left and right rail tubes 104 each hinge on the cross bar 120 and are configured to rotate between a storage position and an extended position. In the storage position, the left and right rail tubes 104 can lock into the handle frame; the left rail tube 104 can lock to the left handle bar tube 102, and the right rail tube 104 can lock to the right handle bar tube 102. This enables a user to shorten the overall length of the pulling rails 106, thereby accommodating the decreased distance needed between the user and the carriage in the push configuration. In the extended position, the left and right rail tubes 104 are extended approximately in line with their respective handle bar tubes 102 and can attach to each other and/or to a bridge piece. This enables a user to use the full length of the pulling rails 106, thereby accommodating the distance needed between the user and the carriage in the pull configuration.

To lock the hinging rail tubes 104 to the handle bar tubes 102, the left and right handle bar tubes 102 can each have a locking mechanism that is comprised of a receiving component affixed to the corresponding handle bar tube 102, wherein each receiving component has a cavity that can receive at least a portion of a rail tube 104. The receiving component can be affixed at any location on the handle bar tube 102, but in a preferred embodiment is affixed near the proximal end of the handle bar tube 102 closest to the wheel axle 1812, and the cavity can face inward toward the opposing handle bar tube 102. Therefore, to lock a rail tube 104 into place, the user can rotate the rail tube 104 to a parallel position with the handle bar tube 102 and can slide the distal end of the rail tube 104 into the cavity. To extend the rail tubes 104 out to the extended position, a user can unlock, or pull out, each rail tube 104 from the locking mechanism and rotate the rail tubes 104 out and away from the carriage. The distal end of the rail tubes 104 can then be pushed together and the rail ends can be locked directly to each other or indirectly to each other via a bridge piece such as a u-joint or attachment bracket 136. The pulling rails 106 can be rotated from the back of the carriage to the front before or after the rail tubes 104 are extended. In a preferred embodiment, the rail tubes 104 are bowed to help enable them to get into close proximity with each other. Once the rail tubes 104 are attached to each other, directly or indirectly, they create a connection point that can be used to attach the stroller to the user or to a dampening system that is, in turn, connected to the user. Attachment of the rail ends or dampening system to the user can occur through use of a running belt 2000, as illustrated in FIGS. 1, 3, 11, and 13.

In a preferred embodiment, the pair of rail tubes 104 can be comprised of a left and a right rail tube 104, wherein the rail tubes 104 can telescope in and out of their respective handle bar tubes 102. For example, in some embodiments, the pair of rail tubes 104 can have a ¾″ diameter and the left and right handle bar tubes 102 can have a 1″ diameter. Therefore, to achieve the storage position, the left and right rail tubes 104 can slide into their respective left and right handle bar tubes 102, and to achieve the extended position, the left and right rail tubes 104 can slide out of their respective left and right handle bar tubes 102. In some embodiments, when extended, the rail tubes 104 can attach at their distal ends to each other or to a bridge piece, such as an attachment bracket 136. The ability of the rail tubes 104 to slide into the handle bar tubes 102 enables a user to shorten the overall length of the pulling rails 106, thereby accommodating the decreased distance needed between the user and the carriage in the push configuration. The telescoping feature also allows the rail tubes 104 to neatly and efficiently stow away when they are not needed.

To lock the telescoping rail tubes 104 inside the handle bar tubes 102 and prevent them from sliding out, or to lock the telescoping rail tubes 104 in their extended position and prevent them from sliding in, one embodiment of the disclosed device includes a split clamp that can be attached at the entry point of the rail tubes 104 into the handle bar tubes 102. More specifically, one half of the split clamp can be a fixed split clamp, and the fixed split clamps can be affixed to the distal ends of the left and right handle bar tubes 102. The second half of the split clamp can be a cam lever operated split clamp, and the cam lever operated split clamps can be, in the locked configuration, affixed to the left and right rail tubes 104. Therefore, when a user opens the cam lever on one side, the user unlocks the split clamp, and the rail tube 104 can slide in and out of the handle bar tube 102. When the user has the rail tube 104 at a desired length, the user can close the cam lever, thereby locking the split clamp and securing the rail tube 104 and the pulling rail 106 at a fixed length.

In another embodiment, the rail tubes 104 can be locked inside the handle bar tubes 102 by using a friction lock, such as a cam lever 132, located near or on the handle frame. For example, the cam lever 132 can be located near the distal ends of the handle bar tubes 102, as illustrated in FIGS. 2, 4, 6, 8, 10, and 15. More specifically, the cam lever 132 can maintain its locked position when it is pushed flush against the handle frame, and the cam lever 132 can be located on both the left and right sides of the handle frame. To unlock the friction lock, a user can pull the cam lever 132 out, thereby releasing pressure from the inner rail tube 104. When the friction lock is unlocked, the rail tube 104 can slide in and out of its corresponding handle bar tube 102. Once a user determines how far in or out the rail tube 104 should be, the user can push the cam lever 132 back in, thereby locking the rail tube 104 in place and fixing the pulling rail 106 at a specific length.

Conversion

In some embodiments, illustrated in FIG. 15, a release or conversion mechanism, such as a swing release or conversion lever 126 mounted on a handle or cross bar 120, can be activated to enable the handle bar assembly to rotate over the top of the carriage. By pulling on the swing release or conversion lever 126, a user can indirectly pull a conversion cable 1802, which releases a conversion lock and permits the user to rotate the handle bar assembly over the top of the carriage.

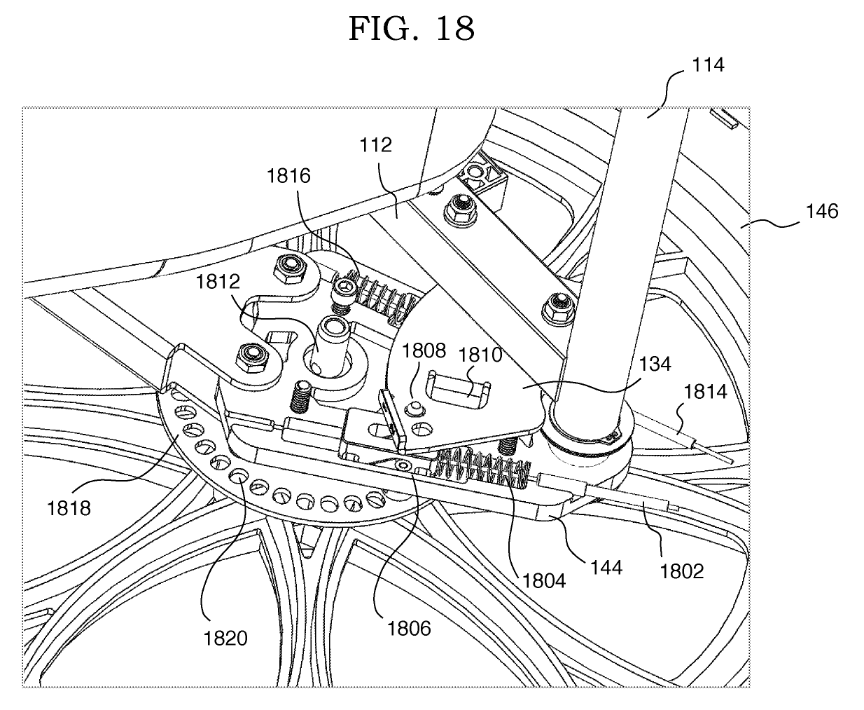

Therefore, in one embodiment and as described in more detail below, there are at least two locking positions: one for the stroller in the push configuration and one for the stroller in the pull configuration. However, in some embodiments, additional positions, locked positions or otherwise, are available so a user can adjust the angle of the pulling rails 106 based on his or her height. In one example, as illustrated in FIG. 18, there is an additional locking position located near the first locking position for the pull configuration resulting in three total locking positions. Therefore, a user can choose between two locking positions in the pull configuration, wherein the difference in the two positions results in a difference in height from the ground to the running belt 2000. In a second example, when a user has the stroller in the pull configuration, the user can leave the pulling rails 106 unlocked from their final pull position. This enables the pulling rails 106 to freely rotate up and down since the rails are not locked into a locking position. If a user proceeds with this use, the stroller may also drop down so that all three wheels are on the ground in the pull position.

In some embodiments, the conversion cable 1802 can be attached to a self-clinching pilot pin, such as a PEM pin, that is secured in a notch on a steel plate. The steel plate can be bolted onto a leg weldment that is attached to a horizontal carriage bar or a wheel axle 1812. When the conversion cable 1802 is pulled forward, it can pull the PEM pin out of the notch, thus permitting rotation of the steel plate and leg weldment. When the leg weldment rotates, it also rotates the horizontal carriage bar or wheel axle 1812, which the handle bar assembly is attached to. Therefore, when the swing release or conversion lever 126 is activated, a user can rotate the handle bar assembly, which will also rotate the leg weldment. This mechanism can take place on one or both rear wheels 146. In one embodiment, there is only one swing release and, to enable the handle bar assembly to rotate over the top of the carriage, the conversion cable 1802 routes from the first side of the stroller to the second. For example, when a user activates the swing release on a first side, such as the left side, it pulls the conversion cable 1802, which pulls the left PEM pin out of the left steel plate and allows the left steel plate, which is attached to the left leg weldment, to freely rotate. The conversion cable 1802 can be routed to the right side of the stroller so that, in addition to pulling on the left PEM pin, it pulls on a right PEM pin, thus pulling the right PEM pin out of the right steel plate and allowing the right steel plate, which is attached to the right leg weldment, to freely rotate.

In a preferred embodiment, illustrated in FIGS. 15 and 18, the conversion mechanism can include a conversion lever 126, a conversion cable 1802, a hub 144, a conversion return spring 1804, a conversion cam profile 1806, a conversion pin 1808, and a conversion plate 134 having a hole for the push configuration and a hole for the pull configuration into which the conversion pin 1808 can extend. The hub 144 can attach to the rear wheel 146 via the wheel axle 1812 and it can attach to the proximal end of one of the handle bar tubes 102, as illustrated in FIGS. 18 and 19, which is attached to one of the rail tubes 104. Further, the hub 144 is the attachment point for the conversion cable 1802, the conversion return spring 1804, the conversion cam profile 1806, and the conversion pin 1808. The conversion plate 134 is permanently affixed to one of the leg risers 112 and also connects to the hub 144 via the conversion pin 1808.

The conversion cable 1802, a portion of which extends inside the conversion return spring 1804, attaches to the front of the conversion cam profile 1806. The conversion cam profile 1806 is open on its left and right sides and has an s-shaped path cut out of its top and bottom surfaces, wherein the s-shaped paths on the top and bottom are in line with each other. Additionally, the conversion cam profile 1806 has a conversion pin 1808 that extends out the left and right sides of the conversion cam profile 1806 and that is attached to bushings or cam rollers that extend through the s-shaped opening on the top and bottom of the conversion cam profile 1806, enabling the conversion cam profile 1806 to move forward and backward relative to the conversion pin 1808. The s-shaped path in the conversion cam profile 1806 prevents the conversion pin 1808 from being externally retracted during the conversion process. A brake cable 1814, brake return spring 1816, brake cam profile (not illustrated), and brake pin (not illustrated) operate in a related manner to the conversion cable 1802, conversion return spring 1804, conversion cam profile 1806, and conversion pin 1808.

In a default state of the conversion mechanism, the conversion return spring 1804 is extended and pushing on the conversion cam profile 1806 so that the conversion pin 1808 is in a location on the s-shaped path that extends it out into the push configuration hole or the pull configuration hole of the conversion plate 134. Therefore, in the default state, the conversion plate 134 is locked in place by the conversion pin 1808. Because the proximal end of the handle bar tube 102 is connected to the hub 144, in the default state when the hub 144 is pinned to the conversion plate 134 via the conversion pin 1808, the handle bar tube 102 is restricted from rotating between the push and pull configurations.

When a user engages the conversion mechanism by moving the conversion lever 126 into an engaged position, the conversion lever 126 pulls on the conversion cable 1802, which pulls the conversion cam profile 1806 toward the conversion return spring 1804, compressing the conversion return spring 1804 and, due to the s-shaped path in the conversion cam profile 1806, causing the conversion pin 1808 to retract out of the conversion plate 134 and outward away from the centerline of the stroller. When the conversion pin 1808 is retracted from the conversion plate 134, the handle bar tube 102, which was held in place due to its connection to the hub 144, is free to rotate between the push and pull configurations. Therefore, for example, if a user engages the conversion mechanism when the stroller is in the pull configuration, the conversion pin 1808 retracts from the pull configuration hole in the conversion plate 134, allowing the user to rotate the handle bar tube 102 over the carriage and into the push configuration.

Once the user releases the conversion lever 126, the conversion lever 126 retracts back into its original position and no longer pulls on the conversion cable 1802. When the conversion cable 1802 is no longer being pulled by the conversion lever 126, the conversion cable 1802 no longer pulls on the conversion cam profile 1806, which allows the conversion return spring 1804 to push the conversion cam profile 1806 back into its default position, which will, due to the s-shaped path in the conversion cam profile 1806, extend the conversion pin 1808 toward the centerline of the stroller and, depending on the positioning of the handle bar tube 102, into the push configuration hole or the pull configuration hole in the conversion plate 134. If the hub 144 and, therefore, the conversion pin 1808 are not lined up properly with the conversion plate 134, however, the conversion pin 1808 will not be able to penetrate either the push configuration hole or the pull configuration hole in the conversion plate 134. Therefore, the handle bar tube 102 will be free to rotate until the conversion pin 1808 and one of the holes lines up. At that time, the handle bar tube 102 will be locked into the pull or push configuration until the conversion lever 126 is again engaged. In one embodiment, even when the conversion pin 1808 is not lined up with a hole in the conversion plate 134, the hub 144 and, by connection, the handle bar tube 102, is restricted from over-travel by conversion plate tabs 1810 located on the edge of the conversion plate 134 that catch the edge of the hub 144. These tabs 1810 act as a hard stop for the conversion mechanism by allowing motion of the hub 144 and the handle bar tube 102 to and between the two tabs' 1810 positions.

In some embodiments, the conversion cam profile 1806 is connected on its rear side to a second conversion cable 1802. The second conversion cable 1802 can wrap around the backside of the carriage and connect to the front of a second conversion cam profile 1806 on the opposite rear wheel 146. Therefore, when the conversion mechanism is engaged, the conversion lever 126 pulls the first conversion cable 1802, which pulls on the first conversion cam profile 1806, which pulls on the second conversion cable 1802, which then pulls on the second conversion cam profile 1806. When the second conversion cam profile 1806 is pulled, it operates in a similar manner to the first conversion cam profile 1806 described above. More specifically, when the second conversion cam profile 1806 is pulled by the second conversion cable 1802, the second conversion cam profile 1806 is pulled toward a second conversion return spring 1804, compressing the second return spring 1804 and, due to an s-shaped path in the second conversion cam profile 1806, causing a second conversion pin 1808 to retract out of a second conversion plate 134 and outward away from the centerline of the stroller. When the first conversion pin 1808 and second conversion pin 1808 are retracted from the first conversion plate 134 and second conversion plate 134, the left and right handle bar tubes 102, which were held in place due to their connection to the first and second hubs 144, are free to rotate between the push and pull configurations.

In some embodiments, as briefly described above, when the handle bar assembly is rotated between the pushing and pulling configurations, as illustrated in the sequence of drawings in FIGS. 17a-17c, the center of mass changes. More specifically, when the left and right handle bar tubes 102 rotate forward and backward, the rear wheels 146, because of their attachment to the hub 144 and, therefore, to the left and right handle bar tubes 102, are translated relative to the seat in the carriage. In a preferred embodiment, the resultant translation of the rear wheels 146 is primarily horizontal and allows for the location of the center of mass relative to the rear wheels 146 to be optimized in both push and pull configurations. In the pull configuration (i.e., running mode), the center of mass of the stroller, occupant, and cargo will be centered over the rear wheels 146 or just slightly forward to limit the amount of weight that is transferred to the user. In the push configuration, the center of mass of the stroller, occupant, and cargo, will be substantially forward of the rear wheels 146 in order to maximize stability against tipping. In some embodiments of the push configuration, the rear wheel movements may make the seat more upright and higher off the ground. For example, the resultant translation of the rear wheels 146 can include a vertical component. This vertical component could change the angle of the seat to a more reclined or vertical position depending on the location of the pulling rails 106.

Stroller Collapse for Transport

Because strollers must be mobile, the disclosed stroller may feature a lightweight, foldable metal or composite frame so it can be collapsed for storage and ease of handling. More specifically, the carriage, wheels, handle bar assembly, and running belt 2000 can be easily folded down to fit inside of the trunk of a car or can be stored in overhead airplane storage. In one embodiment, the center support bars for the seat fold in on each other so that the right and left sides of the stroller are closer in proximity to each other, resulting in a narrower width for the stroller in its folded position.

FIG. 19 illustrate a second embodiment of the folding mechanism for the convertible stroller, wherein, in general, the components in the handle bar assembly and the carriage frame assembly collapse and/or rotate around each other creating a flat, long collapsed structure. Additionally, the rear wheels 146 can be removed and stored. In this embodiment, the stroller frame has the same width in its folded position as it does in its unfolded position, but it has a compact length and height. FIG. 19 illustrates the collapsible frame in the pull configuration, wherein the pulling rails 106 are not fully extended.

In some embodiments, to transition the stroller from its pull configuration into a completely collapsed position, a user can first telescope the left and right rail tubes 104 into the left and right handle bar tubes 102 and rotate the handle bar tubes 102 back over the carriage, thereby converting the convertible stroller from the pull configuration into the push configuration. Next, a user can use a lever or button, such as a conversion lever 126 to pull a cable or cord located along or under the carriage frame, which activates a release mechanism. The release mechanism can be a folding latch that enables the handle bar tubes 102 to rotate forward over the canopy of the carriage. By pulling on the cable or cord, the user also activates locking features that prevent the handle bar tubes 102 from folding and collapsing on their own.

In some embodiments, the handle bar tubes 102 can rotate around a pivot point to move into their collapsed position. This pivot point can be unique from the pivot point used for the conversion mechanism. In some embodiments, to fully collapse the handle bar tubes 102, a combination of two release mechanisms is used. For example, a first release mechanism, such as the folding latch, can be used exclusively for the collapsing feature to rotate the handle bar tubes 102 a majority of the way forward. A second release mechanism, such as a handle release, can then be used to complete the rotation for the collapsing feature. In some embodiments, this second release mechanism is only used for the collapsing feature. In other embodiments, this second release mechanism is the same mechanism used for the conversion feature. For example, a handle release can be used in combination with the folding latch to finish the process of collapsing the convertible stroller or it can be used on its own as a conversion lever 126 to convert the stroller between the push and pull configurations. In some embodiments, the first and the second release mechanisms are the same mechanism and completely transition the stroller into its collapsed position from its push configuration.

In a preferred embodiment, the upper frame 108, the lower frame 110, the legs assembly, comprised of right and leg risers 112 and a leg axle 114, and the carriage cover, comprised of a canopy 116 and a hood 118, can also be folded and/or rotated into flat positions, enabling the entire convertible stroller to lay relatively flat. In some embodiments, the canopy 116 and hood 118 are removable fabric pieces that a user can separate from support rails and the support rails are enabled to fold into flat positions.

In addition to the foldable stroller frame, some or all of the stroller's wheels can also easily be removed for storage. For example, the rear wheels 146 may be removed and the front, third wheel 148 may remain attached, but possibly rotated or folded into a position more in line with the frame. The mechanism used to remove the rear wheels 146 is described in more detail below. Once the entire stroller has been folded, the user can activate the folding latch to prevent any of the folded components from inadvertently unfolding.

In one embodiment, the folded unit would have dimensions no bigger than 36 inches×24 inches×16 inches. The design can allow for the wheels to remain attached, the handle bar assembly to fold up without tools or removable pieces, and the carriage to easily snap open with minimum difficulty. As described above, the rear wheels 146 may be removed before the carriage is folded up. Folding of the frame may occur similar to a tent, wherein an internal cord maintains the proper order for connecting the individual pieces of the frame together.

Carriage Seat

In a preferred embodiment, the seat of the carriage is deep enough to allow for a car seat to be attached (for example, approximately 11 inches deep). Further, as described above, the seat may be positioned over or in front of the wheel axle depending on which configuration the stroller is in. The seat may also adjust in height depending on the stroller's configuration. The seat can have the approximate back height of 20 inches to 24 inches, the approximate width of 14 inches, and a minimum knee-to-foot drop of 6 inches.

In general, the stroller may be wide enough to carry one child. However, in another embodiment, the stroller may be wide enough to carry two children, and can be adaptable to carry only one child or a child plus a few bags of groceries or other cargo. Therefore, the stroller can be designed to allow a child to sit on either side or in the middle of the stroller. The stroller seat can be transitional in order to accommodate infants, toddlers, and young children.

Structurally, the seat can simply be one long bench with a reclining back. The transitions may be possible through add-ons. More specifically, each child's place can be created by customizing an all-in-one seat system and positioning it along the seat bench where desired. The seat system can include two small lateral head supports (i.e. one for each side of the child's head). The head supports can cup the child's head and can be approximately 2.5 inches deep and 3 inches tall. The head supports can be positioned along the seat back to correspond with where the child will sit and how tall the child will be when seated. Two narrow panels of a semi-solid material may run across the rear of the seat back with multiple positioning options. Each panel can be moved higher or lower along the seat back to accommodate taller or shorter children, accordingly. The seat back can have corresponding button-hole-like openings through which the head supports may click into the panel. Shoulder straps can be attached to the head supports to enable appropriate height adjustment. In addition to these features, cushions and/or supports can be included to limit the child's body movement. These supports can be inflatable for adjustability.

In some embodiments, an additional lightweight frame can be inserted into the seat to allow for a standard infant car seat to be clicked into the stroller. The lower head support panel that may run across the back of the seat can also serve as the moveable connection points for the seat frame, such that one car seat can be installed on either side or in the middle of the seat bench. In some embodiments, a second car seat can be installed in the center of the floor. This configuration will usually only be used when a first infant car seat is installed on the bench above. A second car seat frame can connect to secure the second seat below.

In some embodiments, a removable fabric baby carrier can serve as additional support for infants between the ages of three months and twelve months who are developmentally between the car seat and regular seated position. Casements of 1.5 inches can be sewn down the seat back, at both edges, and with two casements evenly spaced between the edges, creating three options for seating spaces for the swaddle seat. For example, the length from the seat bench up the seat back can be 18 inches, which creates 6-inch wide seating spaces for the swaddle seat. Straps for the baby carrier can be fed through the casements and secured in the clips also used for the car seat frame.

The seat belt used for the seat belt system can be a five-point harness with one-inch wide straps. The shoulder straps can hang from the head supports with an adjustable harness attachment connecting the two shoulder straps around the child's mid-chest. The lap belts can be used in isolation to enable the use of a car seat. Therefore, the seat belt can be structured like a pilot's belt, wherein the lap attachment is separate from, but connectable to, the shoulder straps. Two lap belts may be needed, but three positions are possible (each side plus the middle). In some embodiments, three belts can be installed, one for each position. In other embodiments, fewer than three belts are used and the belt(s) can change positions.

In some embodiments, the seat back can recline up to 45 degrees. This can be a simple recline function whereby the seat is designed on a recline and can be drawn forward, with extra fabric being cinched together and secured by tightening a fabric belt across the back of the seat.

Motion Isolation: Running Belt

To be most ergonomic and to avoid stress on the back, the user should pull a stroller using the front of the user's body. Therefore, the stroller frame is secured in a manner that enables it to draw energy directly from the front of the user. For example, the distal end of the pulling rails 106, which include the handle bar tubes 102 and the rail tubes 104, can link the carriage to the user directly behind the user, at the outsides of the user's hips, or in a combination of the two configurations. In one embodiment, the pulling rails 106 are attached to the running belt 2000 on each side of the user while refraining from interference with the arm movement of the user.

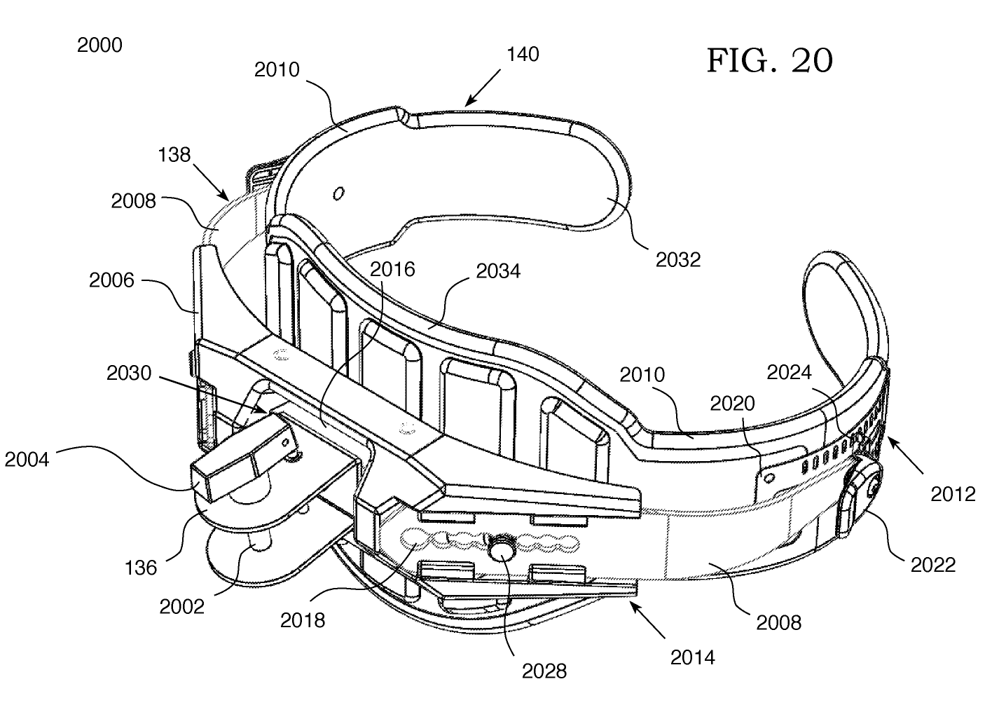

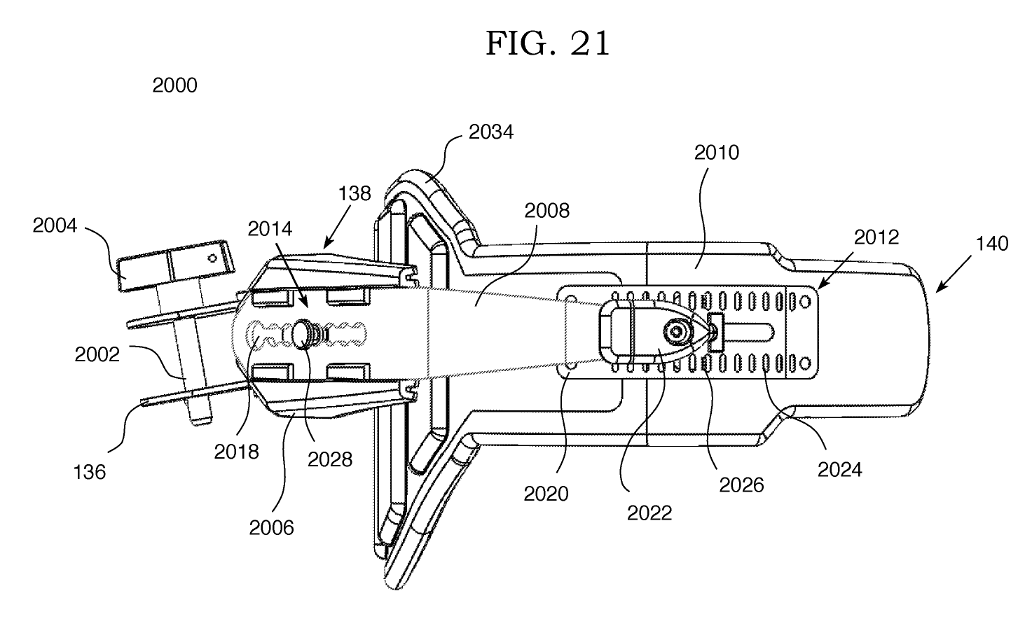

In other embodiments, the distal end of the pulling rails 106 can link to each other or to a bridge piece, such as an attachment bracket 136, before attaching to the user, which creates one connection point on the user, as illustrated in FIGS. 20-21.

In one embodiment, the distal end of the two rail tubes 104 overlap or connect side by side on their rail ends to a horizontal quick release pin on a sheet metal bracket that is attached to the back of the running belt 2000, thereby enabling the handle bar assembly to move up and down when a user is running, but not side to side.

In another embodiment, the distal end of the two rail tubes 104 overlap or connect side by side on their rail ends to a vertical quick release pin on a sheet metal bracket that is attached to the back of the running belt 2000, thereby enabling the handle bar assembly to move side to side when a user is running, but not up and down.

In a further embodiment, the distal end of the two rail tubes 104 overlap or connect side by side on their rail ends to a universal joint on a sheet metal bracket that is attached to the back of the running belt 2000, thereby enabling the handle bar assembly to move side to side and up and down when a user is running. Because the sheet metal bracket that the rail tubes 104 attach to is itself attached to a soft belt, a washer plate or spine plate can be added to the inside of the back of the running belt 2000 to help offer stability.

In yet another embodiment, the two rail tubes 104 overlap or connect side by side on their second rail ends to an attachment bracket 136 that has open sides and an open front for insertion of the two rail tubes 104, as illustrated in FIGS. 1 and 20-21. The attachment bracket 136 may have a quick release pin 2002 that can be inserted through the top and bottom of the attachment bracket 136 and used to secure the two rail tubes 104 to the bracket 136. For example, a user can remove the quick release pin 2002, align the holes in the second ends of the two rail tubs 104 with the attachment bracket's hole in its top and bottom, and insert the quick release pin 2002 into the top of the yoke attachment bracket 136, through the two rail tubes 104, and out the bottom of the yoke attachment bracket 136. The quick release pin 2002 may, in some embodiments, have a handle 2004, as illustrated in FIGS. 20-21, to enable the user to more easily maneuver the pin 2002. An additional benefit to the quick release pin 2002 is that it enables a user who is wearing the running belt 2000 to twist 90 degrees to the left or right without transferring motion to the carriage. This enables better maneuverability around turns.

In some embodiments, the running belt 2000 can include hip cups, padding, cushions, or inflatable regions. The hip cups can be adjustable to accommodate varying hip widths. The running belt 2000 can also be adjustable and can have hip openings to allow for easier leg movement or can have variable heights in different regions of the belt. For example, the back of the running belt 2000 may be taller than the rest of the running belt 2000 to provide additional back support and the sides of the running belt 2000 may be narrower than the rest of the running belt 2000 to allow for easier leg movement. In some embodiments, the running belt 2000 is adjustable at the back, sides, and front, with a closure, such as a belt buckle or other attachment feature, in the front for easy attachment by the user.

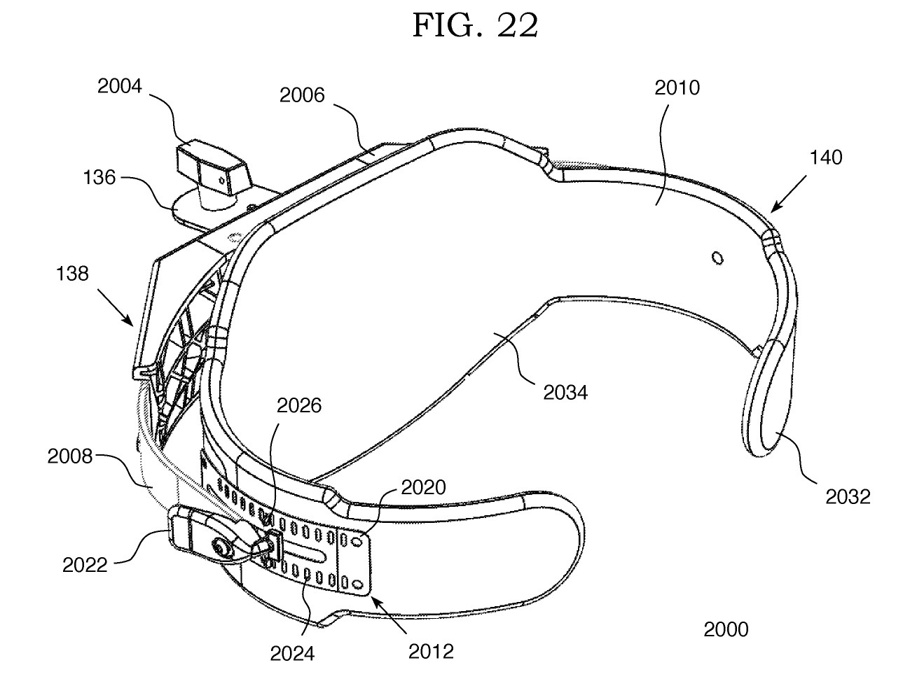

In a preferred embodiment, as illustrated in FIGS. 20-22, the running belt 2000 is comprised of a flexible belt 140, a yoke 138, and a yoke attachment bracket 136. More specifically, the flexible belt 140 attaches directly to the user, the yoke 138 attaches to the flexible belt 140 on the flexible belt sides 2010 leaving space between the two components to allow the yoke 138 to rotate, and the yoke attachment bracket 136 connects the carriage to the running belt 2000. In use, the space between the flexible belt 140 and the yoke 138 enables the yoke 138 to freely rotate up and down without causing the flexible belt 140 to move against the user. Additionally, while the spacing allows the yoke 138 to move, it does not permit the yoke 138 to rotate enough to bump against the user.

The flexible belt 140 is comprised of three main components that can span the entire length of the belt: an upper flexible portion, a rigid center portion, and a lower flexible portion. The yoke 138 is comprised of three main components: a central yoke housing 2006 and left and right yoke sides 2008 that each attach to the flexible belt's left and right sides 2010 using a front/back adjustment system 2012, and that each attach to the central yoke housing 2006 using a width adjustment system 2014. The yoke attachment bracket 136 has a quick release pin 2002 and attaches to the yoke 138 through a spring 2016.

In some embodiments, the three main components of the flexible belt 140 are incorporated onto the outside of a smooth, flat fabric that rests against the user when the user is wearing the running belt 2000. In another embodiment, the upper and lower flexible portions are continuations of the same fabric and the rigid center portion is centrally secured along the outside length of the flexible belt 140. Preferably, the upper and lower flexible portions can adjust independently of each other, with the upper flexible portion likely securing in the front using a hook and loop fastener on a narrower portion of a runner's hips and the lower flexible portion likely securing in the front using a hook and loop fastener on a wider portion of the runner's hips. The rigid center portion preferably has an adjustable buckle in the front that the runner can use to mechanically secure the running belt 2000 to the runner. The benefit of this running belt structure is that the flexible portions provide comfort and individualized adjustability while the rigid center portion provides structure. In some embodiments, the rigid center portion is made of a nylon material. For additional comfort, the flexible belt 140 may have padding along its sides 2010, front 2032, and/or back 2034.

In some embodiments of the yoke 138, the yoke housing 2006 is roughly the width of a user's back and is used for additional size adjustments and as an attachment for the attachment bracket 136. Each of the left and right yoke sides 2008 attaches, on a first end, to their corresponding flexible belt sides 2010 and, on a second end, to their corresponding sides of the central yoke housing 2006. Further, the left and right yoke sides 2008 each have an attachment aperture (not illustrated) on their first ends and adjustment apertures 2018 on their second ends.

More specifically, each yoke side 2008 attaches to the flexible belt 140 using a front/back adjustment system 2012. The front/back adjustment system 2012 of each yoke side 2008 is comprised of a front/back adjustment plate 2020 secured directly to the flexible belt side 2010, a front/back adjustment release lever 2022 that secures the yoke side 2008 in a specific position on the front/back adjustment plate 2020, and a rotation pin assembly (not illustrated) that penetrates the yoke side's attachment aperture (not illustrated) and is secured between the front/back adjustment release lever 2022 and the front/back adjustment plate 2020. The yoke side 2008 can preferably rotate around the rotation pin assembly. In some embodiments, the front/back adjustment plate 2020 has notches 2024 at which the front/back adjustment lever 2022 can secure. In some embodiments, the front/back adjustment lever 2022 has one or more locking tabs 2026 that protrude away from the flexible belt 140 to penetrate through the notches 2024. Therefore, if a user desires to move the yoke 138 further forward, the user can release the front/back adjustment lever 2022, move the locking tab 2026, and therefore the yoke 138, at least one notch 2024 forward, and secure the front/back adjustment lever 2022.

In some embodiments, each yoke side 2008 attaches to the yoke housing 2006 using a width adjustment system 2014. The width adjustment system 2014 on each side of the yoke housing 2006 is comprised of an adjustment button 2028 and a channel having adjustment apertures 2018 through which the left and right yoke sides 2008 can slide. If a user desires to adjust the width of the yoke 138 and make it smaller, the user can push the button 2028 out of a yoke side's adjustment aperture 2018, move the yoke side 2008 further into the channel, and allow the button 2028 to re-penetrate a new adjustment aperture 2018, thereby securing the yoke side 2008 in its new width configuration. The same can then be done on the opposite yoke side 2008.

In some embodiments, the yoke housing 2006 has two width adjustment systems 2014, one on each side as described above, and a central, outward-facing cavity 2030. Within this central cavity 2030 can reside a spring 2016 to which the two rail tubes 104 can directly or indirectly attach. The spring 2016 can be any type of spring that resists a torsional spring moment such as, but not limited to, a compression spring, a tension spring, an elastomeric spring, a leaf spring (for example, a spring steel or composite plastic leaf spring), or a piston. The benefit of the spring 2016 is that it flexes during upward and downward movement of the rail tubes 104 and, therefore, provides motion isolation. This motion isolation feature isolates motion from the stroller that would otherwise transfer to the user and motion from the user that would otherwise transfer to the stroller.

In a preferred embodiment, the spring 2016 used in the central cavity 2030 is a urethane spring that is attached to the central cavity 2030, as illustrated in FIG. 20. The spring 2016 is, preferably, secured to the yoke housing 2006 using a screw (not illustrated). Additionally, in some embodiments, the backside of the yoke housing 2006, opposite the central cavity 2030, may have a plate (not illustrated) to which the screw further attaches. This is used to prevent the stroller from separating from the running belt 2000 in cases where the screw breaks away from the spring 2016.

In embodiments where the spring 2016 is indirectly attached to the two rail tubes 104, a yoke attachment bracket 136 may be used, as described above. The yoke attachment bracket 136 can preferably connect to the spring 2016 using the same screw or screws that attaches the spring 2016 to the central cavity 2030. More specifically, the screw(s) can be inserted through the flat back of the yoke attachment bracket 136, through the spring 2016, through the back of the yoke housing 2006, and out the plate. The space between the yoke 138 and the flexible belt 140 can ensure the screw's tip does not rub against the user.

To better disseminate the weight of the carriage, shoulder straps can be used that can be connected and disconnected to the running belt 2000. The straps may be comfortable for running and pulling (e.g. lightly padded at pressure points, but highly breathable elsewhere). If shoulder straps are used, a front harness to connect the straps may be needed. Alternatively, a lightweight rucksack-like frame that enables the attachment of the stroller frame at a point slightly off the body of the user can be used.

Motion Isolation: Rear Wheel Hub

In some embodiments, the rear wheels 146 can be 20-inch diameter, all-terrain, inflatable wheels with an axle 1812 having a ¾-inch diameter. Preferably, the rear wheels 146 can be removed with quick release buttons or levers. More specifically, any quick release may be used that enables a user to, without any tools, easily detach and reattach the rear wheels 146 to the stroller. For example, a split clamp and cam lever may be used to attach the wheel axle 1812 to the stroller. In another example, a spring opposed release button can be used to lock and unlock the wheel axle 1812 in place.

In one embodiment of a spring opposed release button, the wheel removal mechanism can include a lever having a hole, a wheel axle 1812 having a ring cavity, and a wheel removal spring, wherein the wheel removal spring pushes a portion of the lever into the ring cavity of the wheel axle 1812. When a user wishes to remove the rear wheel 146, the user can push the lever into the wheel removal spring until the hole in the lever lines up with the wheel axle 1812. At that point, the wheel axle 1812 can be pulled through the hole and the rear wheel 146 taken off of the stroller frame.

In other embodiments, the rear wheels 146 can be permanently affixed to the frame. In some embodiments, the rear wheels 146 will have anti-roll capabilities. For example, the rear wheels 146 can be negatively cambered wheels. In some embodiments, the third wheel 148 may be smaller than the other two rear wheels 146, may be retractable, and may deploy when the stroller converts from the pull configuration to the push configuration, as described above. In addition to the motion isolation described above in relation to the running belt 2000, the rear wheels 146 can help provide a quiet, cushioned ride for a child on most surfaces. Further, additional motion isolation methods can be utilized for the benefit of the user and the child.

Because a user may produce multi-axial motion when running with the stroller attached, and transferring this motion to the carriage is undesirable, the use of additional motion isolation can further reduce transfer of multi-axial motion to the carriage and can be implemented in many ways. The first isolation system described can be used at the point of attachment of the handle bar assembly to the user. However, a second isolation system may be used at the point of attachment of the handle bar assembly to the carriage. For example, to isolate the up and down motion of the user, the second isolation system located at the point of attachment of the handle bar assembly to the carriage may include a torsion spring.

In one embodiment, the motion isolation system uses a spring steel stack at the connection point of the pulling rails 106 to the carriage. More specifically, spring steel stacks can be used on the right and left side of the stroller, and each spring steel stack can be fixed on its first end to the handle bar tube 102 and on its second end to the hub 144. The spring steel stack can be kept in place using two clamps, wherein both clamps are attached to the handle bar tube 102 and the spring steel stack. A first clamp is fixed in place and attaches the handle bar tube 102 to the first end of the spring steel stack and a second clamp is a sliding clamp that can move closer to and further from the fixed clamp along the handle bar tube 102 creating different spring rates. The further the sliding clamp gets from the fixed clamp, the less freedom the back end of the spring steel stack will have to move. Therefore, more of the runner's motion will be isolated. The fixed clamp can be a toggle clamp or knob, enabling a user to adjust the spring rate without requiring any tools.

In one embodiment, the motion isolation system uses urethane springs Urethane springs are a preferred motion isolation feature because they provide both elasticity and hysteresis damping. Urethane spring systems, each system being comprised of two urethane springs, a front spring and a rear spring, can be used on the right and left side of the stroller, and each urethane spring system can be fixed on its front end to the handle bar tube 102 and on its rear end to the hub 144. Additionally, the rear end of the front spring and the front end of the rear spring can be fixed in place, leaving only the front end of the front spring and the back end of the rear spring free to move. Therefore, a user operating the convertible stroller in the pull configuration who lifts the handle bar assembly up will cause the rear end of the rear spring to come closer to the front end of the rear spring, thereby compressing the rear spring. Conversely, a user who pushes the handle bar assembly down when the stroller is in the pull configuration will cause the front end of the front spring to come closer to the rear end of the front spring, thereby compressing the front urethane spring. Therefore, as the user causes the handle bar assembly to move up and down while the user is running, the handle bar tubes 102 will activate the urethane springs that will, in turn, isolate the user's motion and prevent the motion from being transferred to the carriage.

Another possible method of motion isolation involves attaching the carriage to the user with a rope or a highly flexible rail(s) that (1) allows energy to be transferred to the carriage exclusively through tension and (2) decouples all other user motions. Shock cords, elastic bands, or linear springs can be implemented for further shock absorption in tension. A braking system may need to be implemented in tandem with this method to stop forward motion of the carriage. Another method involves attachment to the user with a semi-flexible rail(s), which limits the degrees of freedom for motion transfer to primarily forwards and backwards. Still another method involves rigid rails with flexible connections to the user and the carriage (i.e., cantilever springs, elastomeric joints, pivots, and ball-joints). The motion isolation method can be adjustable for different cargo weights and user preferences. Decoupling the user motion from the carriage provides a smoother and more comfortable experience for both user and child.

Along the bottom portion of each of the pulling rails 106, a brace may be attached so that when the stroller is not in use, the frame can rest more upright making it easy to load/unload the child or cargo or to attach the unit to the user. While in motion, the brace may be high enough to prevent interference with the user (i.e. positioned such that the brace does not drag on downward hills). Alternatively, a kickstand may be used to enable easy loading and unloading.

Brakes

Various brakes can be used to ensure the disclosed stroller's safety such as, but not limited to, a hand brake, a parking brake, and a runaway brake. The hand brake may be positioned on the waist belt or on the upper portion of the pulling rails 106, near the user, and can lock for stroller parking. It can also function as an emergency braking system. The hand brake can be a cable brake, similar to that used on a bicycle.

The parking brake can use a brake cable 1814 similar to that used on a bicycle. More specifically, the brake cable 1814 can be activated at the end of the rail tubes 104, if a user is in the pull configuration, or at the end of the handle bar tubes 102, if the user is in the push configuration. The brake cable 1814 can be threaded through the pulling rails 106 from the point of activation to the actual brake mechanism on the wheel hub 144.

In one embodiment, the brake mechanism can be comprised of a hub 144 that attaches to the rear wheel 146 and is the attachment point for the brake cable 1814, the spring steel stack, and a flat sheet metal part with a PEM standoff attached to the brake cable 1814 that rotates the flat sheet metal part when the brake cable 1814 is activated so that a PEM pin that is positioned lower on the flat sheet metal part pivots and locks into a sprocket 1818 bolted to the rear wheel 146. When the PEM pin pivots into the sprocket 1818, it prevents the rear wheel 146 from turning further and, effectively, brakes the stroller. In some embodiments, this braking mechanism exists on both sides of the stroller. In other embodiments, this braking mechanism exists on one side of the stroller, such as the right side, while a similar braking mechanism with slight modification can exist on the other side of the stroller, such as the left side. For example, the brake cable 1814 from the first side of the stroller can be routed around or through the stroller to the second side. More specifically, if the brake cable 1814 is threaded through the right pulling rail 106, when it is pulled, it routes from the right side of the stroller to the left side of the stroller, where it then pulls on a second PEM standoff attached to a second flat sheet metal part. The rotation of the flat sheet metal part when it is pulled by the PEM standoff, rotates a second PEM pin into place in a second sprocket 1818 bolted to the left rear wheel 146. Even though this example describes the brake cable 1814 as routed from the right side of the stroller to the left side of the stroller, the brake cable 1814 can alternatively be routed from the left side of the stroller to the right side of the stroller. Therefore, the brakes on both the right and left rear wheels 146 are approximately simultaneously activated because activation of the brake cable 1814 on the right rear wheel 146 pulls the brake line for the left rear wheel 146.

Another embodiment of the brake mechanism, illustrated in FIG. 18, can be comprised of a hub 144, a brake cable 1814, a brake return spring 1816, a brake cam profile (not illustrated), a brake pin (not illustrated), and a sprocket 1818. The hub 144 can attach to the rear wheel 146 and the sprocket 1818, which has several sprocket holes 1820 for accepting the brake pin and is directly attached to the rear wheel 146. Additionally, the hub 144 is the attachment point for the brake cable 1814, the motion isolation system, the brake return spring 1816, the brake cam profile, and the brake pin. As mentioned above, the brake cable 1814, brake return spring 1816, brake cam profile, and brake pin operate in a related manner to the conversion cable 1802, conversion return spring 1804, conversion cam profile 1806, and conversion pin 1808.

The brake cable 1814, a portion of which extends inside the brake return spring 1816, attaches to the front of the brake cam profile. The brake cam profile (not illustrated) is open on its left and right sides and has an s-shaped path cut out of its top and bottom surfaces, wherein the s-shaped paths on the top and bottom are in line with each other. Additionally, the brake cam profile has a brake pin (not illustrated) that extends out the left and ride side of the brake cam profile and that is attached to bushings or cam rollers that extend through the s-shaped opening on the top and bottom of the brake cam profile, enabling the brake cam profile to move forward and backward relative to the brake pin. The s-shaped path in the brake cam profile prevents the brake pin from being externally retracted when the parking brake is engaged.

In a default state of the disengaged brake mechanism, the brake return spring 1816 is compressed and the brake cam profile (not illustrated) is pulled forward by the brake cable 1814 so that the brake pin (not illustrated) is in a location on the s-shaped path that retracts it from the sprocket holes 1820 in the sprocket 1818. Therefore, in the default, disengaged state, the sprocket 1818 is free to rotate. Because the rear wheel 146 is connected directly to the sprocket 1818, in the default, disengaged state when the sprocket 1818 is free to rotate, the rear wheel 146 is also free to rotate.

More specifically, when a parking brake lever 128 is in a disengaged position, the parking brake lever 128 is pulling on the brake cable 1814, which pulls the brake cam profile (not illustrated) toward the brake return spring 1816, compressing the brake return spring 1816, and, due to the s-shaped path in the brake cam profile, causing the brake pin (not illustrated) to retract out of a sprocket hole 1820 and toward the centerline of the stroller. When the brake pin is retracted from the sprocket hole 1820, the rear wheel 146, which is directly connected to the sprocket 1818, is free to rotate and the stroller can be pushed or pulled.

When a user engages the parking brake, for example, by lifting the parking brake lever 128 away from the cross bar 120, the parking brake lever 128 relaxes the constriction of the brake cable 1814. When the brake cable 1814 is less constricted and, therefore, no longer pulling on the brake cam profile (not illustrated), the brake return spring 1816 will push the brake cam profile forward. When the brake cam profile is pushed forward, it will, due to the s-shaped path in the brake cam profile, extend the brake pin (not illustrated) outward away from the centerline of the stroller and into one of the holes in the sprocket 1818, thereby preventing further movement of the sprocket 1818 and, because of its attachment to the sprocket 1818, the rear wheel 146. If none of the sprocket holes 1820 are lined up properly with the brake pin, however, the brake pin will not be able to penetrate a sprocket hole 1820. Therefore, the rear wheel 146, which is attached to the sprocket 1818, will be free to rotate until the brake pin and one of the sprocket holes 1820 line up with each other. At that time, the sprocket 1818 and the rear wheel 146 will be locked in place until the parking brake lever 128 is disengaged. In some embodiments, initial engagement of the parking brake lever 128 may exert additional stress on the brake cable 1814 until a certain rotation point is reached, at which time the brake mechanism will snap into engagement because of the release of the brake return spring 1816.

In some embodiments, the brake cam profile (not illustrated) is connected on its rear side to a second brake cable 1814. The second brake cable 1814 can wrap around the backside of the carriage and connect to the front of a second brake cam profile (not illustrated) on the opposite rear wheel 146. Therefore, when the brake mechanism is disengaged, the parking brake lever 128 pulls the first brake cable 1814, which pulls on the first brake cam profile, which pulls on the second brake cable 1814, which then pulls on the second brake cam profile. When the second brake cam profile is pulled, it operates in a similar manner to the first brake cam profile described above. More specifically, when the second brake cam profile is pulled by the second brake cable 1814, the second brake cam profile is pulled toward a second brake return spring 1816, condensing the brake return spring 1816 and, due to an s-shaped path in the second brake cam profile, causing a second brake pin (not illustrated) to retract out of a second brake plate and toward the centerline of the stroller. When the first brake pin (not illustrated) and second brake pin are retracted from sprocket holes 1820 in the first sprocket 1818 and second sprocket 1818, the left and right rear wheels 146, which were locked in place due to their connection to the first sprocket and second sprocket 1818, are free to rotate.

Similarly, when the brake mechanism is engaged, the parking brake lever 128 releases the first brake cable 1814, which allows the first brake return spring 1816 to push on the first brake cam profile (not illustrated), which releases the second brake cable 1814, which then allows the second brake return spring 1816 to push on the second brake cam profile (not illustrated). Therefore, when the brake mechanism is engaged, the first brake return spring 1816 and second brake return spring 1816 push on the first cam profile and second brake cam profile and, due to the s-shaped paths on the first and second brake cam profiles, the brake cam profiles cause the first brake pin (not illustrated) and second brake pin (not illustrated) to extend into sprocket holes 1820 in the first sprocket 1818 and second sprocket 1818. When the first and second brake pins extend into the first and second sprockets 1818, the left and right rear wheels 146, which are directly attached to the first and second sprockets 1818, are then locked in place.

To prevent the stroller from pushing the user when moving downhill, an automatic braking system can be included to provide “drag” as the stroller encounters steeper declines. This brake system can be adjusted to match the weight of the load or it can be disengaged completely. Further, an adjustable amount of braking can be engaged to provide additional resistance for training purposes.

The attachment point of the handle bar assembly to the running belt 2000 may also include hand-held back-up steering. The rail tube 104 that connects to the running belt 2000 may have five inches of a foam-like grip near the point of connection to the running belt 2000. By grasping the tubing, the user can accentuate steering or guide the stroller over unstable terrain. In addition, the user may occasionally need to push the stroller while in the pull configuration (e.g. to park it) and the grips can facilitate this use. Finally, the grip can facilitate use of the emergency hand-brake connection.

Stroller Storage and Additional Features

Behind the seat and within the carriage, there can be ample space for storage. Two zipper openings in the back can give entrance to a large sack that can house extra gear and a small pocket for keys, ID, etc. The stroller can also have elasticized, large netting pockets sewn on the seat ends (i.e. inside the core half-pod). These pockets can be five inches wide, four inches tall, and can store drink bottles, toys, etc. Additionally, pockets can be included on the back of the carriage. The pockets can be elastic so that, when they are not in use, they fit snug against the carriage. They can also have an elastic or zipper opening. In some embodiments, they can be mesh pockets to allow airflow within the pocket itself.

In some embodiments, a permanent or removable backpack can be located on the back of the carriage. The backpack can be directly attached to the top of the carriage seat, and the sides of the backpack can be additionally secured along the bottom of the carriage seat so that it remains out of view when a user views the stroller from above. When needed, the backpack can then swing out for easy access. The backpack can take on various shapes and can have a several different types of compartments, such as zipper openings, netted pockets, elastic openings, etc. In some embodiments, different backpacks can be swapped out, providing a user with several backpack options depending on the user's needs.

In some embodiments, the stroller can have LED lighting and/or reflectors to enable the stroller to be easily visible in dim or dark lighting. These lights and/or reflectors can be located on the sides and back of the stroller and along the frame that attaches to the user.

Other features that the stroller can include are electronics, such as speakers, fans, and mobile device mounting; bike computer/tachometer integration for statistics; on-board activities such as a horn/bell or steering wheel; and a mirror for child visibility.

In an alternative embodiment, the stroller can be configured to attach to the rear portion of a bicycle and operate in the pull configuration. Various types of attachments permit current bicycle carts to connect to bicycles. However, existing bicycle carts, which are bulky and heavy, are not designed to be pushed and pulled directly by a user and, in fact, would be unsafe for the runner or walker given those carts' standard rigid connection between seating portion and bicycle. In one embodiment, the stroller could be connected to a bicycle through use of a bridge piece, such as the attachment bracket 136.

In some embodiments, the carriage can be constructed using different measurements and sturdier materials in order to accommodate activities other than pulling a child. For example, athletes may use a variant of the above-described stroller, such as a weight-bearing carriage, for endurance and strength training. In another example, the carriage size may be increased to enable wheelchair-free transportation of older children or adults with disabilities.

What is claimed is:

1-20. (canceled)

21. A convertible stroller comprising:
a carriage;
a plurality of wheels;
pulling rails; and
a conversion mechanism for converting the stroller between a push configuration having the pulling rails in a first locked position that is behind the carriage and a pull configuration having the pulling rails in a second locked position that is in front of the carriage;
wherein the pulling rails are angled upward when they are locked in the second position.

22. The convertible stroller of claim 21, wherein activation of the conversion mechanism enables the stroller to convert between the first locked position, the second locked position, and a third locked position.

23. The convertible stroller of claim 22, wherein the pulling rails in the third locked position are closer to ground than the position of the pulling rails in the second locked position.

24. The convertible stroller of claim 21, further comprising one conversion lever, wherein activation of the one conversion lever releases the pulling rails from any of the first or second locked positions.

25. The convertible stroller of claim 24, wherein the one conversion lever is located on a cross bar.

26. The convertible stroller of claim 25, wherein:
the pulling rails include a first and a second pulling rail; and
the cross bar connects the first pulling rail to the second pulling rail at a first location along the pulling rails.

27. The convertible stroller of claim 21, wherein:
the pulling rails include a first and a second pulling rail;
the first and the second pulling rails are configured to move between a shortened position and a lengthened position; and
each of the first and the second pulling rails includes a tube and an extension piece.

28. The convertible stroller of claim 27, wherein each extension piece connects, on a distal end, to a bridge piece, and the bridge piece further connects to a pulling means.

29. The convertible stroller of claim 28, wherein:
the plurality of wheels further comprises two rear wheels and a front wheel; and
when the pulling rails are in the second locked position and the pulling rails are connected to the pulling means, the front wheel is elevated off the ground.

30. The convertible stroller of claim 28, the pulling means is selected from the group consisting of a running belt, a bicycle, and a motorized vehicle.

31. The convertible stroller of claim 27, wherein each extension piece is configured to slide in and out of its respective tube to transition the pulling rails between the shortened position and the lengthened position.

32. The convertible stroller of claim 31, wherein:
a cross bar connects the first tube to the second tube at a location on each of the tubes; and
a bridge piece connects the first extension piece to the second extension piece at a location on each of the extension pieces.

33. The convertible stroller of claim 21, wherein the carriage includes a seat for a child.

34. The convertible stroller of claim 33, wherein the seat translates horizontally and vertically relative to at least one of the plurality of wheels when the pulling rails convert between the first locked position and the second locked position.

35. The convertible stroller of claim 21, further comprising a release mechanism for converting the stroller into a collapsed configuration having the pulling rails positioned in front of the carriage and approximately parallel to ground.

36. A method of converting a stroller from a push configuration to a pull configuration, the method comprising:
engaging a conversion mechanism to unlock pulling rails from a first position behind a carriage;
rotating the pulling rails forward over the carriage from the first position behind the carriage to a second position at an upward angle in front of the carriage; and
disengaging the conversion mechanism to lock the pulling rails in the second position.

37. The method of claim 36, wherein the stroller is converted from the pull configuration to the push configuration, the method further comprising:
engaging the conversion mechanism to unlock the pulling rails from the second position in front of the carriage;
rotating the pulling rails backward over the carriage from the second position in front of the carriage to the first position behind the carriage; and
disengaging the conversion mechanism to lock the pulling rails in the first position.

38. The convertible stroller of claim 37, wherein the stroller is converted from the push configuration to a collapsed configuration, the method further comprising:
engaging a release mechanism to unlock the pulling rails from the first position behind the carriage;
rotating the pulling rails forward over the carriage from the first position behind the carriage to a collapsed position in front of the carriage until the pulling rails are approximately parallel to the ground; and
disengaging the release mechanism.

39. The method of claim 36, wherein the stroller is converted from the pull configuration to a second pull configuration, the method further comprising:
engaging the conversion mechanism to unlock the pulling rails from the second position in front of the carriage;
rotating the pulling rails further forward from the second position to a third position at an upward angle in front of the carriage;
disengaging the conversion mechanism to lock the pulling rails in the third position.

40. The convertible stroller of claim 38, wherein:
the conversion mechanism comprises a conversion lever; and
the conversion lever is located on a cross bar.
